(19) United States
(12) Patent Application Publication
(10) Pub. No.: US 2022/0325810 A1
(43) Pub. Date: Oct. 13, 2022

(54) VALVE CARTRIDGE, VALVE CARTRIDGE KIT, VALVE INCORPORATING A VALVE CARTRIDGE OR VALVE CARTRIDGE KIT AND A METHOD OF ASSEMBLING A VALVE

(71) Applicant: Australian Valve Group Pty Ltd, Kewdale (AU)

(72) Inventors: Peter John Morris, Canning Vale (AU); Marcus Eric Ullrot, Highgate (AU)

(21) Appl. No.: 17/715,542

(22) Filed: Apr. 7, 2022

(30) Foreign Application Priority Data
Apr. 8, 2021 (AU) 2021901033
Mar. 25, 2022 (AU) 2022900764

(51) Int. Cl. F16K 15/02; F16K 27/02

(52) U.S. Cl. CPC F16K 15/026; F16K 27/0209

(57) ABSTRACT

A valve cartridge (1) having a body (10), a piston (12) and a piston support (22). The body has a seat (14). The piston (12) is supported on the piston support (22) and movable between first and second positions. The piston (12) is spaced from the valve seat (14) at the first position and the piston (12) seats on the valve seat (14) at the second position. The piston (12) and piston support (22) form a confined space. The volume of the confined space is at a maximum when the piston (12) is at the first position and is at a minimum when the piston (12) is at the second position. The piston (12) is under bias such that the piston (12) is biased away from the valve seat (14) to the first position and, in use, the piston (12) is able to seat on the valve seat (14) in the second position when subjected to sufficient pressure to counter the bias.

### CROSS REFERENCE TO RELATED APPLICATIONS

The present application claims priority to Australian Provisional Patent Application No. 2021901033, filed Apr. 8, 2021, and Australian Provisional Patent Application No. 2022900764, filed Mar. 25, 2022, both of which are fully incorporated herein by reference.

Throughout this specification, unless the context requires otherwise, the word “comprise” and variations such as “comprises”, “comprising” and “comprised” are to be understood to imply the presence of a stated integer or group of integers but not the exclusion of any other integer or group of integers.

Throughout this specification, unless the context requires otherwise, the word “include” and variations such as “includes”, “including” and “included” are to be understood to imply the presence of a stated integer or group of integers but not the exclusion of any other integer or group of integers.

The headings and subheadings in this specification are provided for convenience to assist the reader, and they are not to be interpreted so as to narrow or limit the scope of the disclosure in the description, claims, abstract or drawings.

### TECHNICAL FIELD

The present invention relates to a valve cartridge, valve cartridge kit, a valve incorporating a valve cartridge, a valve incorporating a valve cartridge kit and a method of assembling a valve.

### BACKGROUND

Any discussion of background art, any reference to a document and any reference to information that is known or is well known, which is contained in this specification, is provided only for the purpose of facilitating an understanding of the background art to the present invention, and is not itself an acknowledgement or admission that any of that material forms part of the common general knowledge in Australia or any other country as at the priority date of the application in relation to which this specification has been filed.

In plumbing installations, pressure limiting valves (also referred to as a “pressure reducing valves” in the art) are used to limit the pressure of a fluid that is able to flow through the pressure limiting valve, to the downstream side of the valve, to a maximum set pressure. Such valves are useful in plumbing installations as they can be installed upstream of appliances and plumbing devices to ensure that those appliances and plumbing devices are not exposed to excessively high fluid pressures that may intermittently occur in the plumbing installation and cause damage to the appliances or plumbing devices. However, existing valves of this type are typically relatively large and may not be readily deployed at desirable locations in plumbing installations.

### SUMMARY

In accordance with one aspect of the present invention, there is provided a valve cartridge comprising

a body provided with a valve seat,

a piston,

a piston support to support the piston whereby the piston is movably supported by the piston support such that the piston is movable between a first position and a second position, the piston being spaced from the valve seat at the first position and the piston seating on the valve seat at the second position,

wherein the piston and the piston support form a confined space, with the piston supported on the piston support, and

wherein the volume of the confined space is at a maximum when the piston is at the first position and is at a minimum when the piston is at the second position, and

wherein the piston is under bias such that the piston is biased away from the valve seat to the first position and, in use, the piston is able to seat on the valve seat in the second position when subjected to sufficient pressure to counter the bias.

The body may be provided with the piston support.

The valve cartridge may further comprise a piston retainer to retain the piston with the piston support.

The piston may be supported on the piston support in a sliding manner, i.e. the piston is slidably supported on the piston support.

A valve seat retainer may be provided to retain the valve seat in position on the body.

The piston may have a first end and a second end with an opening at the first end. The piston may be supported by the piston support such that at least a portion of the piston support is received in an internal space of the piston.

At least one seal may be provided between the piston support and the piston. The seal forms a fluid-tight seal between an inner surface of the piston and an outer surface of the piston support.

The piston may be biased away from the valve seat by compressed air in the confined space formed by the piston and the piston support.

The piston may be biased away from the valve seat by a spring.

The spring may be positioned in the confined space formed by the piston and piston support.

The piston may be provided with a first internal space. The first internal space forms at least part of the confined space.

The piston support may be provided with a second internal space. The second internal space forms at least part of the confined space.

In another embodiment, the piston support is provided with a second internal space, but the second internal space does not form part of the confined space. A wall may be provided at a first end of the piston support such that the second internal space does not form part of the confined space.

In another embodiment, the piston support is not provided with a second internal space.

At least one seal may be provided at an outer surface of the body.

A first opening may be provided in the body and a second opening may be provided in a wall of the piston support. A passage may extend between the first and second openings, such that the exterior of the body is in communication with the confined space.

First and second seals may be provided at an outer surface of the body. The first opening is located between the first and second seals.

In accordance with another aspect of the present invention, there is provided a valve comprising a

a valve body having an inlet and an outlet, the valve body comprising a first body section and a second body section,

a valve cartridge as herein before described,

the first and second body sections being detachably connected together with the valve cartridge retained in the valve body,

wherein, in use, fluid is able to flow from the inlet through the valve cartridge to the outlet when the piston is in the first position and fluid is not able to flow from the inlet through the valve cartridge to the outlet when the piston is in the second position.

In accordance with another aspect of the present invention, there is provided a valve cartridge kit comprising

a body provided with a valve seat,

a piston,

a piston support, in use, adapted to support the piston whereby, in use, the piston is movably supported by the piston support such that the piston is movable between a first position and a second position, the piston being spaced from the valve seat at the first position and the piston seating on the valve seat at the second position,

wherein the piston and the piston support form a confined space when the piston is supported on the piston support, and

wherein the volume of the confined space is at a maximum when the piston is at the first position and is at a minimum when the piston is at the second position, and

wherein, in use, the piston is under bias such that the piston is biased away from the valve seat to the first position and, in use, the piston is able to seat on the valve seat in the second position when subjected to sufficient pressure to counter the bias.

The valve cartridge kit may further comprise a spring, in use, to bias the piston away from the valve seat.

The valve cartridge kit may further comprise a piston stop.

The piston of the valve cartridge kit may be provided with a first internal space. The first internal space forms at least part of the confined space.

In one embodiment of the valve cartridge kit, the piston support is provided with a second internal space. The second internal space forms at least part of the confined space.

In another embodiment of the valve cartridge kit, the piston support is provided with a second internal space, but the second internal space does not form part of the confined space. A wall may be provided at a first end of the piston support such that the second internal space does not form part of the confined space.

In another embodiment of the valve cartridge kit, the piston support is not provided with a second internal space.

At least one seal may be provided at an outer surface of the body of the valve cartridge kit.

A first opening may be provided in the body of the valve cartridge kit and a second opening may be provided in a wall of the piston support. A passage may extend between the first and second openings, such that the exterior of the body of the valve cartridge kit is in communication with the confined space.

First and second seals may be provided at an outer surface of the body of the valve cartridge kit. The first opening is located between the first and second seals.

In accordance with another aspect of the present invention, there is provided a valve comprising

a valve body having an inlet and an outlet, the valve body comprising a first body section and a second body section,

a valve cartridge kit, as herein before described, installed in the valve body to form a valve cartridge,

the first and second body sections being detachably connected together with the components of the valve cartridge kit retained in the valve body,

wherein, in use, fluid is able to flow from the inlet through the valve cartridge to the outlet when the piston is in the first position and fluid is not able to flow from the inlet through the valve cartridge to the outlet when the piston is in the second position.

In accordance with another aspect of the present invention, there is provided a method of assembling a valve comprising

providing a valve body having an inlet and an outlet, the valve body comprising a first body section and a second body section,

installing the components of the valve cartridge kit, as herein before described, which comprises

inserting the piston into the second body section, inserting the body of the valve cartridge into the second body section such that at least a portion of the piston support is received in the internal space of the piston, and attaching together the first and second body sections.

The method may further comprise inserting a spring into the internal space in the piston prior to inserting the body into the second body section.

The method may further comprise inserting a piston stop into the second body section prior to inserting the piston into the second body section.

The valve cartridge is also referred to herein as a cartridge for a valve.

### BRIEF DESCRIPTION OF DRAWINGS

The present invention will now be described, by way of example only, with reference to the accompanying drawings, in which:

FIG. 1 is a first perspective of a first embodiment of a valve cartridge in accordance with an aspect of the present invention;

FIG. 2 is a second perspective view of the valve cartridge shown in FIG. 1;

FIG. 3 is a first exploded view of the valve cartridge shown in FIG. 1;

FIG. 4 is a second exploded view of the valve cartridge shown in FIG. 1;

FIG. 5A is a first cross sectional side view of the valve cartridge shown in FIG. 1;

FIG. 5B is a second cross sectional side view of the valve cartridge shown in FIG. 1;

FIG. 6A is a first cross sectional side view of a second embodiment of a valve cartridge in accordance with an aspect of the present invention;

FIG. 6B is a second cross sectional side view of the valve cartridge shown in FIG. 6A;

FIG. 6C is a first cross sectional side view of a third embodiment of a valve cartridge in accordance with an aspect of the present invention;

FIG. 6D is a second cross sectional side view of the valve cartridge shown in FIG. 6C;

FIG. 7 is a cutaway perspective view of a fourth embodiment of a valve cartridge in accordance with an aspect of the present invention;

FIG. 8 is a first exploded view of a first embodiment of a valve in accordance with another aspect of the present invention;

FIG. 9 is a second exploded view of the valve shown in FIG. 8;

FIG. 10 is a first cross sectional side view of the valve shown in FIG. 8, in its assembled condition, incorporating the valve cartridge shown in FIG. 7;

FIG. 11 is a second cross sectional side view of the valve shown in FIG. 8, in its assembled condition, incorporating the valve cartridge shown in FIG. 7;

FIG. 12 is a third cross sectional side view of the valve shown in FIG. 8, in its assembled condition, incorporating the valve cartridge shown in FIG. 7;

FIG. 13 is an exploded view of another embodiment of a valve that includes a first embodiment of a valve cartridge kit in accordance with another aspect of the present invention;

FIG. 14 is an exploded view of another embodiment of a valve that includes a second embodiment of a valve cartridge kit in accordance with another aspect of the present invention;

FIG. 15 is a first cross sectional side view of the valve shown in FIG. 14, in its assembled condition;

FIG. 16 is a second cross sectional side view of the valve shown in FIG. 14, in its assembled condition;

FIG. 17 is an exploded view of another embodiment of a valve that includes a third embodiment of a valve cartridge kit in accordance with another aspect of the present invention;

FIG. 18 is an exploded view of another embodiment of a valve that includes a fourth embodiment of a valve cartridge kit in accordance with another aspect of the present invention;

FIG. 19 is a first cross sectional side view of the valve shown in FIG. 18, in its assembled condition;

FIG. 20 is a second cross sectional side view of the valve shown in FIG. 18, in its assembled condition;

FIG. 21 is an exploded view of a fifth embodiment of a valve cartridge in accordance with an aspect of the present invention;

FIG. 22A is a first cross sectional side view of the valve cartridge shown in FIG. 21;

FIG. 22B is a second cross sectional side view of the valve cartridge shown in FIG. 21;

FIG. 23 is an exploded view of a sixth embodiment of a valve cartridge in accordance with an aspect of the present invention;

FIG. 24A is a first cross sectional side view of the valve cartridge shown in FIG. 23;

FIG. 24B is a second cross sectional side view of the valve cartridge shown in FIG. 23;

FIG. 25 is a first exploded view of another embodiment of a valve in accordance with another aspect of the present invention;

FIG. 26 is a first cross sectional side view of the valve shown in FIG. 25, in its assembled condition, incorporating the valve cartridge shown in FIG. 21; and

FIG. 27 is a second cross sectional side view of the valve shown in FIG. 25, in its assembled condition, incorporating the valve cartridge shown in FIG. 23.

### DESCRIPTION OF EMBODIMENTS

The same reference numerals are used to denote the same or equivalent parts in the embodiments described herein. Such parts that are described with reference to one or more embodiments are not again described with reference to the other embodiments described herein. It is to be understood that the description of such parts and their use and operation with reference to such one or more embodiment/s also applies to the other embodiment/s.

Air Only. Open Ended Piston

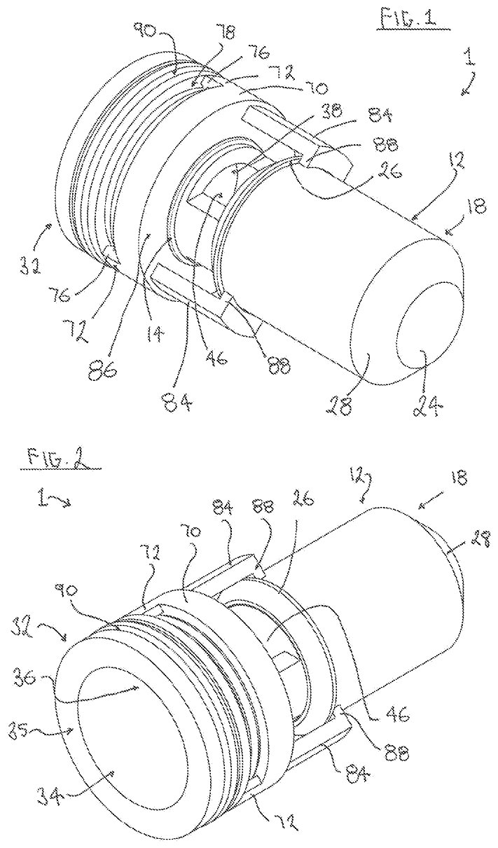

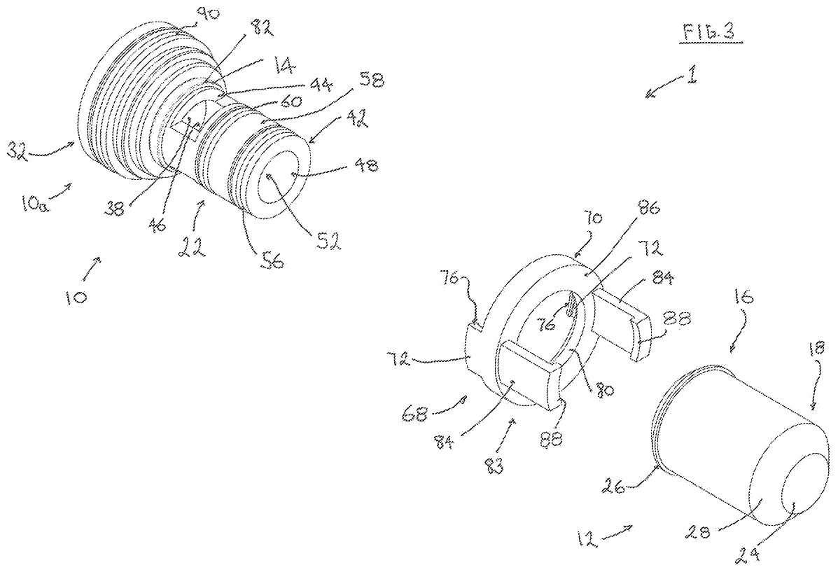

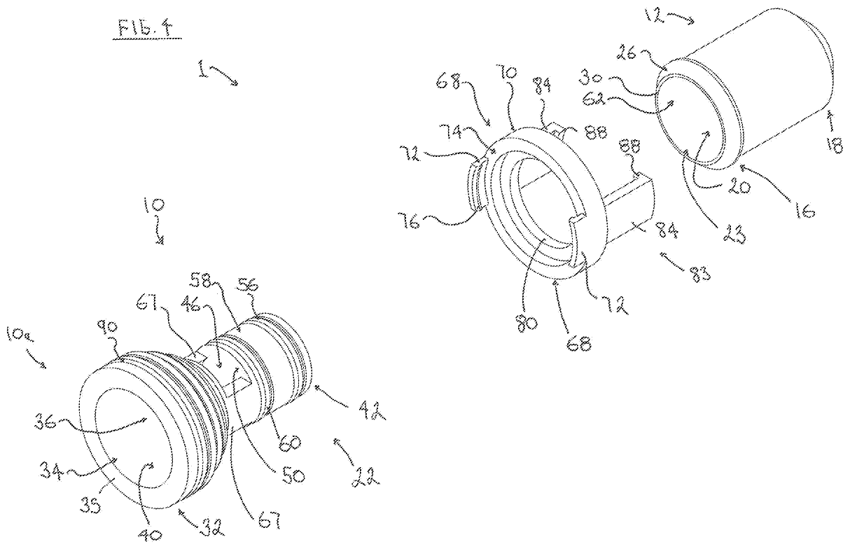

In FIGS. 1 to 6, there is shown a first embodiment of a cartridge 1 for a valve (also referred to herein as a valve cartridge 1) comprising a body 10 and a valve piston (also referred to herein as a piston) 12. The body 10 has a sealing body portion 10a. The sealing body portion 10a, as will be further herein described. The body 10 is provided with a valve seat 14. The piston 12 has a first end 16 and a second end 18. The piston 12 is open at the first end 16. The piston 12 is closed at the second end 18. An internal space 20 is provided in the piston 12. The internal space is provided between the first and second ends 16 and 18 of the piston 12. A piston support 22 supports the piston 12. The piston 12 is under bias such that the piston 12 is biased away from the valve seat 14 to a first position, as will be further described herein. In the first position, the piston 12 is spaced from the valve seat 14. The first position of the piston 12 is also referred to herein as the first (open) position and the open position. In use, in the first position, fluid is able to flow through the valve cartridge 1, as will be further described herein. In use, the first end 16 of the piston 12 is able to seat on the valve seat 14 in a second (closed) position, when the piston is subjected to sufficient pressure to counter the bias, as will also be further described herein. The second position of the piston 12 is also referred to herein as the second (closed) position and the closed position

The piston 12 has an opening 23 at the first end 16. The piston 12 has an end wall 24 at the second end 18. The end wall 24 closes the second end 18. The piston 12 is provided with a bevelled (e.g. frusto-conical) flange 26 at the first end 16. The bevelled flange 26 tapers outwardly in the direction from the first end 16 to the second end 18 of the piston 12. The piston 12 is provided with a bevelled edge 28 at the second end 18.

The piston 12 is supported by the piston support 22 such that it can move along the piston support 22, i.e. the piston 12 is movably supported on the piston support 22. The piston 12 is able to move along the piston support in a sliding manner, i.e. the piston 12 is slidably supported on the piston support 22.

The body 10 is provided with the piston support 22.

The body 10 comprises the sealing body portion 10a and the piston support 22.

The piston 12 is provided with a seating surface 30 at the first end 16. The seating surface 30 is shaped to match the shape of the valve seat 14. Typically, the valve seat 14 and the seating surface 30 each have a ring or annular shape. In use of the valve cartridge 1, the seating surface 30 at the first end 16 of the piston 12 is able to seat on the valve seat 14 of the body 10 in the second (closed) position of the piston 12.

The body 10 has a first, or inlet, end 32. A first opening 34 is provided at the first end 32. An abutment surface 35 is provided at the first end 32. The abutment surface 35 is substantially annular. The first opening 34 forms the inlet of the valve cartridge 1. A passage, or flow-way, 36 extends through the body 10 from the first opening 34 to a second opening 38. The passage 36 extends through the sealing body portion 10a. The wall 40 of the passage 36 may be sloped whereby it is substantially frusto-conical in shape such that the wall 40 of the passage 36 slopes inwardly (i.e. it narrows) in the direction from the first opening 34 to the second opening 38.

The piston support 22 has a first (distal) end 42 and a second (proximal) end 44.

The second opening 38 is located adjacent to the second end 44 of the piston support 22. The sealing body portion 10a extends from the first end 32 of the body 10 to the second opening 38. One or more openings 46 are provided in the piston support 22 near the second end 44. In the drawings, the piston support 22 is provided with two such openings 46. The opening/s 46 form the outlet/s of the valve cartridge 1.

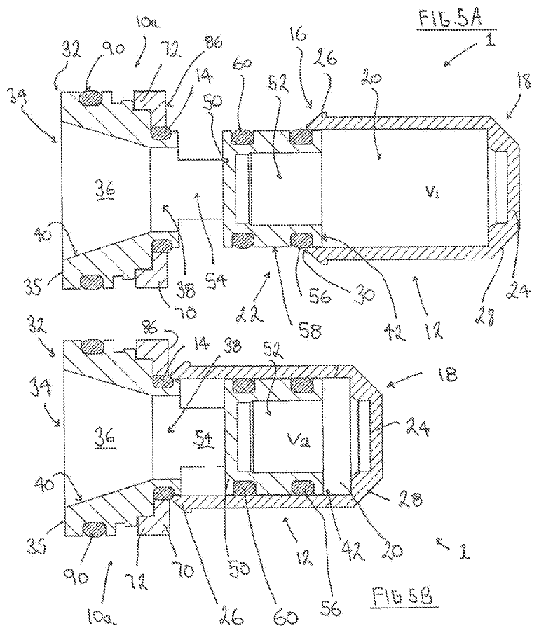

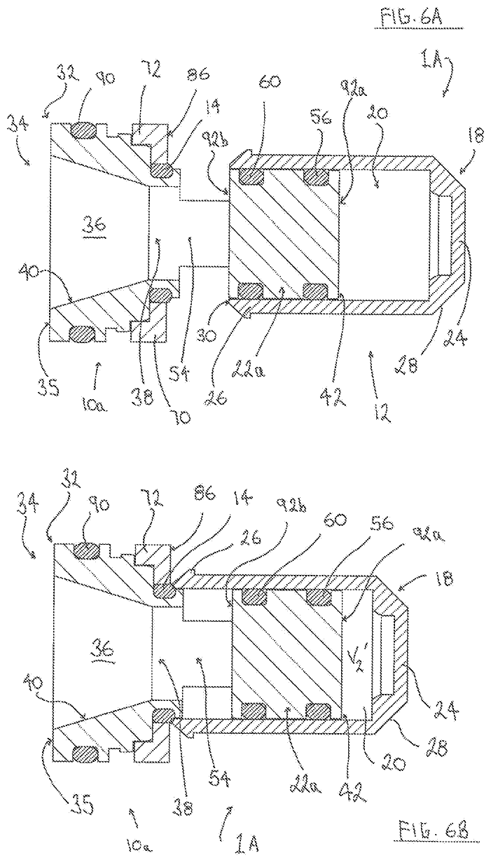

The piston support 22 is provided with an opening 48 at the first end 42. A wall 50 is provided inside the piston support 22. The wall 50 is best seen in FIGS. 5, 6 and 7. The wall 50 divides the space inside the piston support 22 into two sections. An internal space 52 is formed between the first end 42 and the wall 50. Another space 54 (best seen in FIGS. 5A and 5B) is provided between the second end 44 of the piston support 22 and the wall 50. The passage 36 and the space 54 are in fluid communication via the second opening 38.

A fluid flow path is formed from the first opening 34, through the passage 36 to the second opening 38 and the space 54 to the openings 46.

The piston support 22 is provided with at least one seal 56, for example an O-ring, on its external surface 58. However, the piston support 22 may be provided with one or more additional seals, such as the seal 60, for example an O-ring, shown in the drawings. However, given the relatively small dimensions of the piston support 22, two seals 56 and 60 would usually be the most that would be accommodated on the piston support 22.

The first seal 56 is located adjacent to the first end 42 of the piston support 22. The second seal 60 is located adjacent to the openings 46.

The first end 42 of the piston support 22 is received, via the opening 23 at the first end 16 of the piston 12, in the internal space 20 of the piston 12 such that the piston 12 is mounted on the piston support 22. The internal surface 62 of the piston 12 contacts the seals 56 and 60 such that fluid cannot pass beyond the seals 56 and 60 into the internal space 20 of the piston 12 or the internal space 52 of the piston support 22.

A confined space is formed by the piston 12 and the piston support 22. Since the piston support 22 has an opening at the first end 42 and since the piston 12 is supported on the piston support 22, the confined space comprises a portion of the internal space 20 of the piston 12 and the internal space 52 of the piston support 52. The volume of the confined space is variable. The volume of the confined space formed by the portion of the internal space 20 and the internal space 52 varies between a maximum volume when the piston 12 is at the first position and a minimum volume when the piston 12 is at the second position.

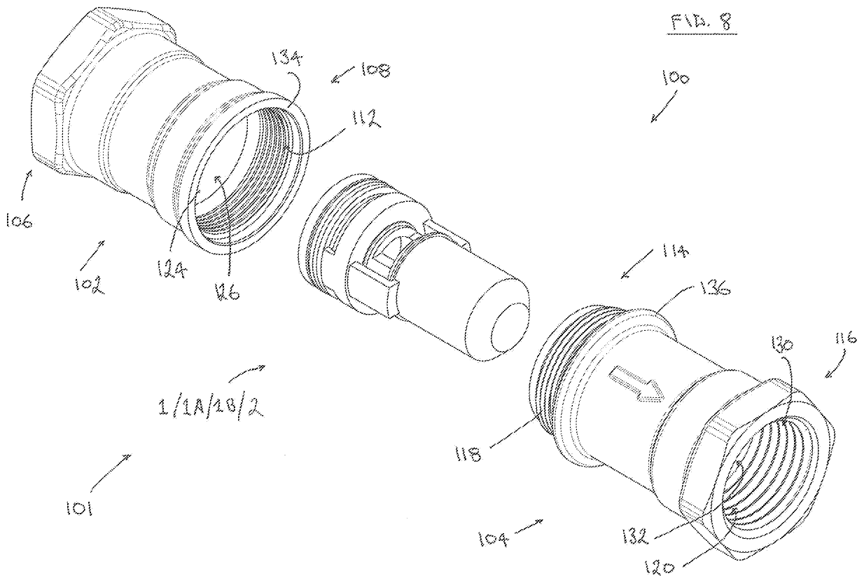

The valve seat 14 is positioned proximate the second end 44 of the piston support 22. The valve seat 14 is positioned on a projecting portion 66 of the body 10. The valve seat 14 is positioned on the sealing body portion 10a. The sealing body portion l0a is provided with the projecting portion 66. The projecting portion 66 is best seen in FIG. 7. The second end 44 of the piston support 22 abuts with the projecting portion 66. FIG. 7 shows a fourth embodiment of a valve cartridge 2, which is further described later herein. The valve cartridges 1 and 2 share many features in common and some features are best seen in FIG. 7. Accordingly, reference is made to FIG. 7 in relation to some of the features of the valve cartridge 1. The valve seat 14 may be provided as an O-ring.

The piston support 22 extends from the sealing body portion 10a. The piston support 22 extends from the sealing body portion l0a at the projecting portion 66. The second end 44 of the piston support 22 is provided adjacent the sealing body portion 10a. The second end 44 of the piston support 22 is provided adjacent the sealing body portion l0a at the projecting portion 66. The piston support 22 has one or more portions 67 that extend from the sealing body portion l0a to the wall 50, as best seen in FIG. 4. In the drawings, the piston support 22 is provided with two such portions 67.

The valve cartridge 1 further comprises a valve seat retainer 68 to retain the valve seat 14 in position. The valve seat retainer 68 comprises a ring 70 having lugs 72 extending from a first face 74 of the ring 70. The lugs 72 have ends 76 spaced from the ring 70. The ends 76 of the lugs 72 are turned inwardly such that they engage in a groove 78 on the body 10 to attach the valve seat retainer 68 to the body 10. The (circular) inner surface 80 of the ring 70 abuts the (circular) outer surface 82 of the valve seat 14. In this way the valve seat retainer 68 retains the valve seat 14 in position on the projecting portion 66 of the body 10 proximate the second end 44 of the piston support 22. This is best seen in FIG. 7.

The valve cartridge 1 further comprises a piston retainer 83 to retain the piston 12 on the piston support 22. The piston retainer 83 comprises lugs 84 extending from a second face 86 of the ring 70. The first and second faces 74 and 86 of the ring 70 are opposed. The lugs 84 have ends 88 spaced from the ring 70. The ends 88 of the lugs 84 are turned inwardly and are positioned behind the bevelled flange 26 of the piston 12. Since the piston 12 is biased away from the valve seat 14 to an open position, in the fully open position the ends 88 of the lugs 84 abut the bevelled flange 26 at the first end 16 of the piston. The piston 12 is thereby retained on the piston support 22.

The body 10 is provided with a seal 90 near the first end 32. The seal 90 is provided at an outer surface of the body 10. The seal 90 is positioned in a groove 91 on the body 10 near the first end 32. The seal and the groove 91 are provided on the sealing body portion 10a. The groove 91 is best seen in FIG. 7. The seal 90, for example, may be an O-ring.

The piston 12 is biased away from the valve seat 14 to an open position by air contained in the internal space 20 of the piston 20 and the internal space 52 of the piston support 22. In that regard, FIG. 5A shows the valve cartridge 1 with the piston 12 about to be mounted on the piston support 22. The first end 42 of the piston support 22 is received in the internal space 20 of the piston 12 and the first end 16 of the piston 12 is positioned adjacent to the seal 56 on the piston support 22. This relative position of the piston 12 and piston support 22 corresponds to the initial volume of air (V₁) in the confined space formed by the piston 12 and piston support 22. This initial volume substantially equates to the sum of volumes of the internal spaces 20 and 52 of the piston 12 and piston support 22, respectively, at ambient pressure. Once the first end 16 of the piston 12 passes over the seal 56, air cannot escape from the internal confined space that is confined by the piston 12 and piston support 22. As the piston 12 passes further over the piston support 22, the first end 42 of the piston support 22 is received further into the internal space 20 of the piston. As this occurs, the volume of the internal space confined by the piston 12 and piston support 22 reduces. As the volume of the internal space confined by the piston 12 and piston support 22 reduces, the air in the internal space confined by the piston 12 and piston support 22 is compressed. This compressed air biases the piston 12 away from the valve seat 14 to the open (first) position. With continued movement of the piston 12 further over the piston support 22, the first end 16 of the piston 12 will pass over the second seal 60 on the piston support 22 and then pass past the bevelled flange 26, at the first end 16 of the piston 12. At that point, the ends 88 of the lugs 84 of the piston retainer 83 abut behind the bevelled flange 26. This abutment of the ends 88 of the lugs 84 with the bevelled flange 26 retains the piston 12 on the piston support 22. Due to the retention of the piston 12 on the piston support 22, the biasing action of the compressed air in the internal space confined by the piston 12 and piston support 22 cannot displace the piston 12 off the piston support 22. This is the fully open position of the piston 12 and is shown in various figures in the drawings of the first and other embodiments, including FIGS. 1, 2, 6A and 7.

If the piston 12 is moved further toward the seal 14, against the biasing action of the compressed air in the internal space confined by the piston 12 and piston support 22, the volume of the internal space confined by the piston 12 and piston support 22 further reduces. In addition, the air in the internal space confined by the piston 12 and piston support 22 is further compressed further. The limit of travel of the piston 12 will be reached when the first end 16 of the piston 12 seats on (i.e. abuts) the seal 14.

As herein before described, in use, the first end 16 of the piston 12 is able to seat on the valve seat 14 of the body 10 in a second (closed) position. The closed position of the valve cartridge 1 is shown in FIG. 5B. In the closed position of the valve cartridge 1, the seating surface 30, at the first end 16 of the piston 12, seats (i.e. abuts) on the seal 14.

This relative position of the piston 12 and piston support 22 corresponds to the minimum volume of air (V₂) in the space confined by the piston 12 and piston support 22. It also corresponds to the maximum compression of air in the confined space. In contrast, the maximum volume of air and minimum compression of air in the confined space occurs when the piston 12 is in the first position.

Air Only. Solid Piston

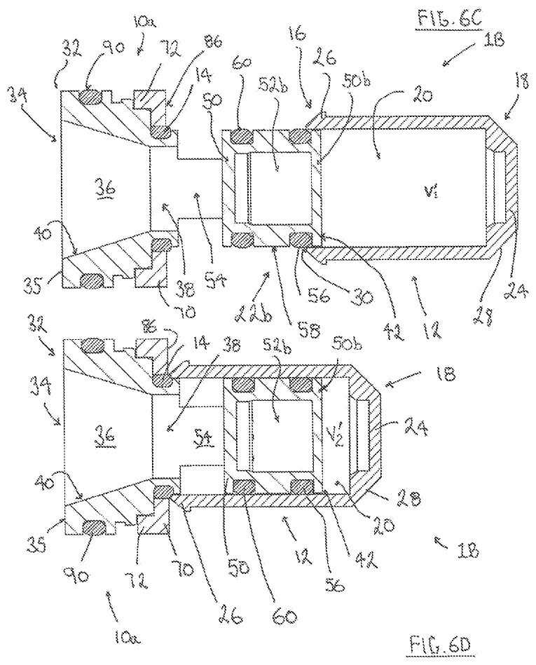

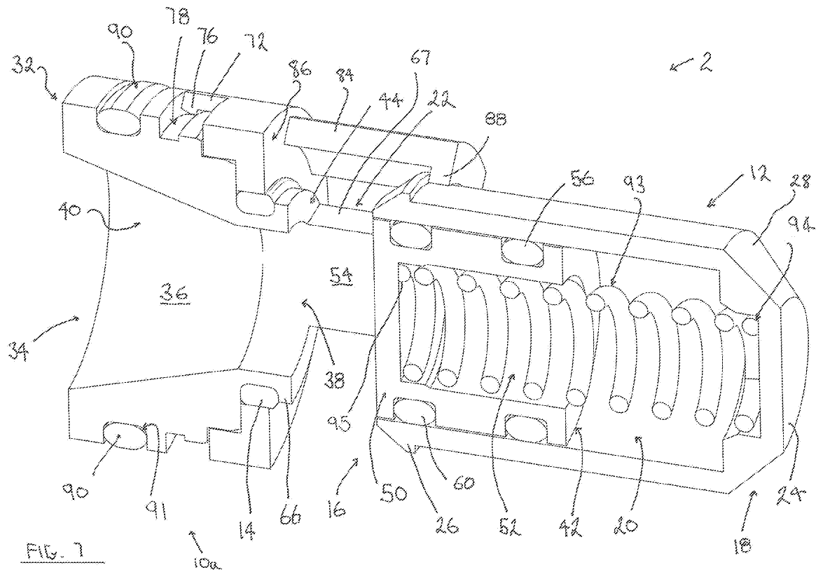

In FIGS. 6A and 6B, there is shown a second embodiment of a cartridge 1A for a valve (also referred to herein as a valve cartridge 1A).

FIG. 6A shows the valve cartridge 1A in the fully open condition. In this condition (as is the case in the other embodiments described herein when the valve cartridge is in the open condition), the piston 12 is in the first (open) position). FIG. 6B shows the valve cartridge 1A in the closed condition. In this condition (as is the case in the other embodiments described herein when the valve cartridge is in the closed condition), the piston 12 is in the second (closed) position.

The valve cartridge 1A of the second embodiment is similar to the valve cartridge 1 of the first embodiment, except that the piston support 22a of the valve cartridge 1A has a solid portion (whereas in the valve cartridge 1 of the first embodiment, the corresponding portion is not solid since the corresponding portion of the valve cartridge 1 is the internal space 52). Consequently, the piston support 22a of the valve cartridge 1A does not have an opening 48 at the first end 42 and does not have an internal space 52. Instead, the piston support 22a of the valve cartridge 1A has a first face 92a at the first end 42 and a second face 92b. The second face 92b is provided at one end of the space 54 (in similar manner to the wall 50 of the valve cartridge 1). Thereby, the space 54 is provided between the second end 44 of the piston support 22a and the second face 92b of the piston support 22a.

Air Only. Hollow Piston

In FIGS. 6C and 6D, there is shown a third embodiment of a cartridge 1B for a valve (also referred to herein as a valve cartridge 1B).

FIG. 6C shows the valve cartridge 1B with the piston 12 about to be mounted on the piston support 22b. FIG. 6D shows the valve cartridge 1B in the closed condition. In this condition, the piston 12 is in the second (closed) position.

The valve cartridge 1B of the third embodiment is similar to the valve cartridge 1 of the first embodiment, except that the piston support 22b of the valve cartridge lb is provided with a wall 50b at the first end 42 of the piston support 22b. An internal space 52b is formed inside the piston support 22b between the walls 50 and 50b. Thereby, the piston support 22b is hollow. The internal space 52b of the piston support 22b is isolated from the internal space 20 of the piston 12 by the wall 50b.

### Spring Included

In FIG. 7, there is shown a fourth embodiment of a cartridge 2 for a valve (also referred to herein as a valve cartridge 2).

The valve cartridge 2 of the fourth embodiment is similar to the valve cartridge 1 of the first embodiment, except that the valve cartridge 2 further comprises a spring 93. The spring 93 is provided between the piston 12 and piston support 22. In particular, the spring 93 is provided in the internal space confined by the piston 12 and the piston support 22. A first end 94 of the spring 93 abuts the end wall 24 of the piston 12 and a second end 95 of the spring 93 abuts the wall 50 inside the piston support 22.

The spring 93 provides additional biasing force (i.e. in addition to the biasing force of the compressed air in the internal space confined by the piston 12 and the piston support 22 as herein before described) to bias the piston 12 away from the valve seat 14 to the open (first) position. The greater the spring force of the spring 93, the greater will be the biasing force that it imparts on the piston 12. Accordingly, the valve cartridge 2 of the third embodiment is suitable for applications in which greater biasing force is required than can be provided by only the compressed air in the internal space confined by the piston 12 and the piston support 22.

### Valve Incorporating a Valve Cartridge

A valve cartridge 1, 1A, 1B or 2 (valve cartridge 1/1A/1B/2) of the first, second, third or fourth embodiments may be provided in a valve. In particular, the valve cartridge 1/1A/1B/2 may be a component or part of a valve, such as a pressure control valve, in particular a pressure limiting valve (also referred to as a “pressure reducing valve” in the art) or a valve that incorporates a pressure limiting valve.

A pressure limiting valve functions to limit the pressure of a fluid that is able to flow through the pressure limiting valve, to the downstream side of the valve, to a maximum set pressure, i.e. a pressure limiting valve limits the downstream pressure to the set pressure of the pressure limiting valve, such that the downstream pressure of the fluid cannot exceed the set pressure. The set pressure of the pressure limiting valve may be selected and set at the time of manufacture of the pressure limiting valve.

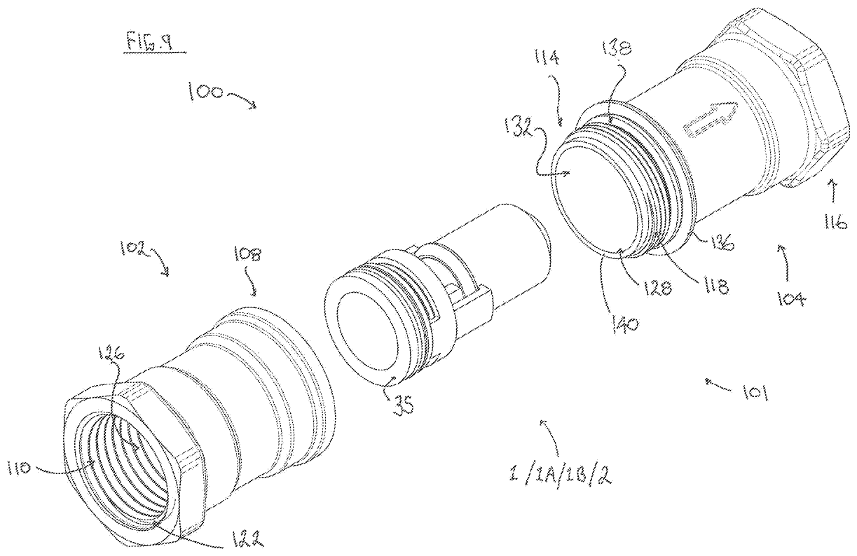

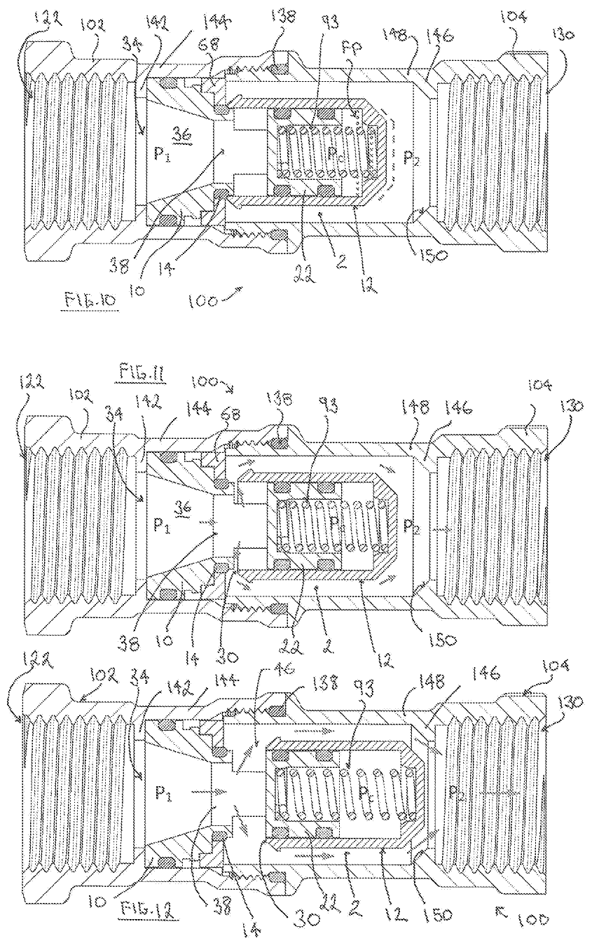

In FIGS. 8 and 9, there is shown an embodiment of a valve 100 comprising a valve body 101 and a valve cartridge 1/1A/1B/2. The valve body 101 comprises a first body section, or part, 102 and a second body section, or part, 104. Only some of the parts of the valve cartridge 1/1A/1B/2 have been identified by reference numbers in FIGS. 8 and 9. However, reference may be made to FIGS. 1 to 7 to identify the reference numbers for the other parts of the valve cartridge 1/1A/1B/2.

The first and second body sections 102 and 104 are detachably connected together. The body sections 102 and 104 may be connected together with the valve cartridge 1/1A/1B/2 retained in the body 101, comprised of the body sections 102 and 104, during assembly of the valve 100. In the event that the valve cartridge 1/1A/1B/2 requires maintenance or replacement, the body sections 102 and 104 can be detached to allow access to the valve cartridge 1/1A/1B/2 for maintenance or replacement. Once maintenance or replacement of the valve cartridge 1/1A/1B/2 has been performed, a valve cartridge 1/1A/1B/2 can be reinstalled in position and the body sections 102 and 104 can be reconnected together again.

The first and second body sections 102 and 104 are substantially cylindrical in shape. The first body section 102 has a first end 106 and a second end 108. The first body section 102 is provided with first and second screw threads 110 and 112. The screw threads 110 and 112 are provided adjacent to the first and second ends 106 and 108, respectively. The second body section 104 has a first end 114 and a second end 116. The second body section 104 is provided with first and second screw threads 118 and 120. The screw threads 118 and 120 are provided adjacent the first and second ends 114 and 116, respectively.

The first body section 102 is provided with first and second openings 122 and 124, respectively. The first opening 122 is provided at the first end 106 and the second opening 124 is provided at the second end 108 of the first body section 102. A passage 126 extends through the first body section 102 between the openings 122 and 124. The second body section 104 is provided with first and second openings 122 and 124, respectively. The first opening 128 is provided at the first end 114 and the second opening 130 is provided at the second end 116 of the second body section 104. A passage 132 extends through the second body section 104 between the openings 128 and 130.

The first and second body sections 102 and 104 are detachably connected together by the screw threads 112 and 118 of the first and second body sections 102 and 104, respectively. The first body section 102 is provided with an abutment surface 134. The abutment surface 134 is located at the second end 108 of the first body section 102. The abutment surface 134 is substantially annular. The second body section 104 is provided with a flange 136. The flange 136 is located near the end of the screw thread 118 that is spaced from the first opening 128 of the second body section 104. section

With reference to FIGS. 10, 11 and 12, the valve 100 is provided with a seal 138 between the first and second body sections 102 and 104.

When the first and second body sections 102 and 104 are connected together, the abutment surface 134 of the first body section 102 abuts with the flange 136 of the second body section 104. The seal 138 is sandwiched between the first and second body sections 102 and 104. The seal 138 prevents fluid leaking from inside the valve 100 through the connection between the first and second body sections 102 and 104. The seal 138 may be provided on the second body section 104. The seal 138 may be positioned between the flange 136 and the end of the screw thread 118 that is spaced from the first opening 128 of the second body section 104.

The second body section 104 is provided with an abutment surface 140. The abutment surface 140 is located at the first end 114 of the second body section 104. The abutment surface 140 is substantially annular.

The first body portion 102 is provided with a shoulder 142. The shoulder 142 is located inside the passage 126. The shoulder 142 extends from the wall 144 of the first body portion 102. The shoulder 142 is substantially annular.

The second body portion 104 is provided with a shoulder 146. The shoulder 146 is located inside the passage 132. The shoulder 146 extends from the wall 148 of the second body section 104. The shoulder 146 is substantially annular. The shoulder 146 has a bevelled face 150. The bevelled face 150 tapers inwardly in the direction toward the second opening 132.

When the first and second body sections 102 and 104 are connected together, with the cartridge valve 1/1A/1B/2 retained in the body sections 102 and 104, the valve cartridge 1/1A/1B/2 is retained in the first and second body sections 102 and 104. The abutment surface 35 at the first end 32 of the body 10 abuts the shoulder 142 of the first body section 102 and the abutment surface 140 of the second body portion 104 abuts the second face 86 of the ring 70 of the valve seat retainer 68. These abutments clamp the valve cartridge 1/1A/1B/2 between the shoulder 142 and the abutment surface 140. Accordingly, the valve cartridge 1/1A/1B/2 is retained in the body 101 of the valve 100. The seal 90 of the valve cartridge 1/1A/1B/2, which is positioned on the sealing body portion 10a, is in fluid-tight abutment with the inside surface of the body 101. The seal 90 thereby forms a seal between the sealing body portion l0a of the valve cartridge 1/1A/1B/2 and the first body section 102.

The first opening 122 (of the first body section 102 of the valve body 101) forms the inlet (of the valve body 101) of the valve 100. The second opening 124 (of the second body section 104 of the valve body 101) forms the outlet (of the valve body 101) of the valve 100.

Since the seal 90 on the sealing body portion l0a forms a seal between the valve cartridge 1/1A/1B/2 and the first body section 102, fluid that enters the valve 100, via the first (inlet) opening 122, cannot flow between the valve cartridge 1/1A/1B/2 and the first body section 102. The fluid can flow only through the first opening 34 into the passage 36 of the valve cartridge 1/1A/1B/2.

### Use

The use and operation of a valve cartridge 1/1A/1B/2 and a valve 100 will now be described. The valve 100 operates as a pressure limiting valve.

In use, the valve 100 is installed in a plumbing installation (not shown), e.g. a domestic or commercial plumbing installation. The valve 100 is connected to a fluid supply line, e.g. a water supply line, of the plumbing installation using the screw thread 110. The valve 100 is connected to a fluid delivery line of the plumbing installation using the screw thread 120. Typically, the fluid delivery line delivers the fluid (typically water) to an appliance, e.g. a dishwasher, or to an outlet, e.g. a tap or faucet. Whilst the first and second body parts 102 and 104 of the valve 100 have been described as having screw threads 110 and 120 to connect the valve 100 to the plumbing installation, any suitable type of connectors may be used that enable the valve 100 to be connected into the plumbing installation.

By way of example, FIGS. 10, 11 and 12 show the valve 100 with a valve cartridge 2. The valve cartridge 2 includes a spring 93. FIGS. 10, 11 and 12 show the valve 100 with the piston 12 of the valve cartridge 2 in three different positions.

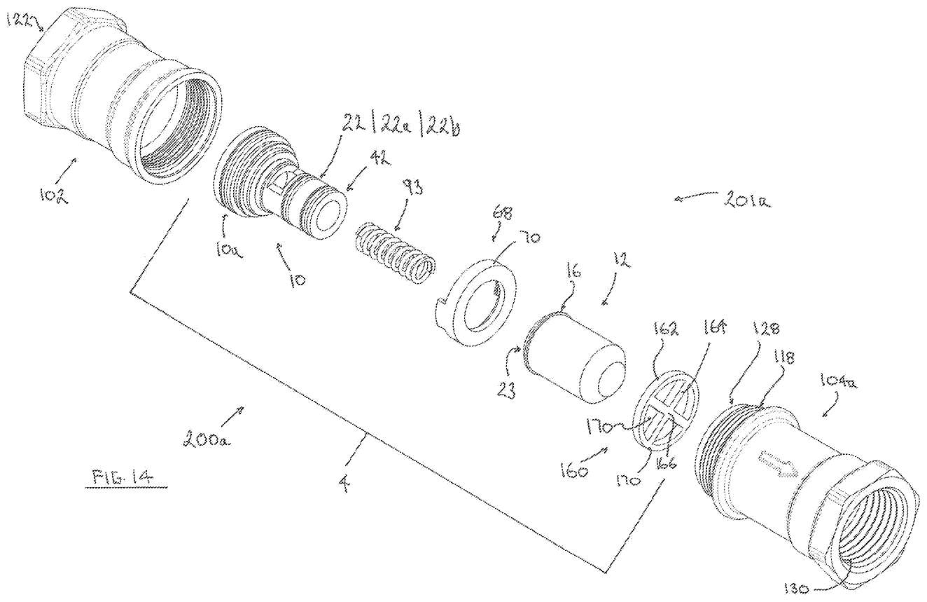

The spring 93 and the compressed air in the internal space confined by the piston 12 and piston support 22 are at their minimum compression when the piston 12 is in the first position (shown in FIG. 12) and are at their maximum compression when the piston 12 is in the second position (shown in FIG. 10).

The volume of the confined space is at a maximum when the piston 12 is at the first position and is at a minimum when the piston 12 is at the second position.

In FIG. 10, the piston 12 is shown in the closed (second) position, i.e. closed condition of the valve cartridge 2 and the valve 100. In the closed position of the piston 12, the seating surface 30 seats on the valve seat 14 and fluid cannot pass through the valve cartridge 2 or the valve 100.

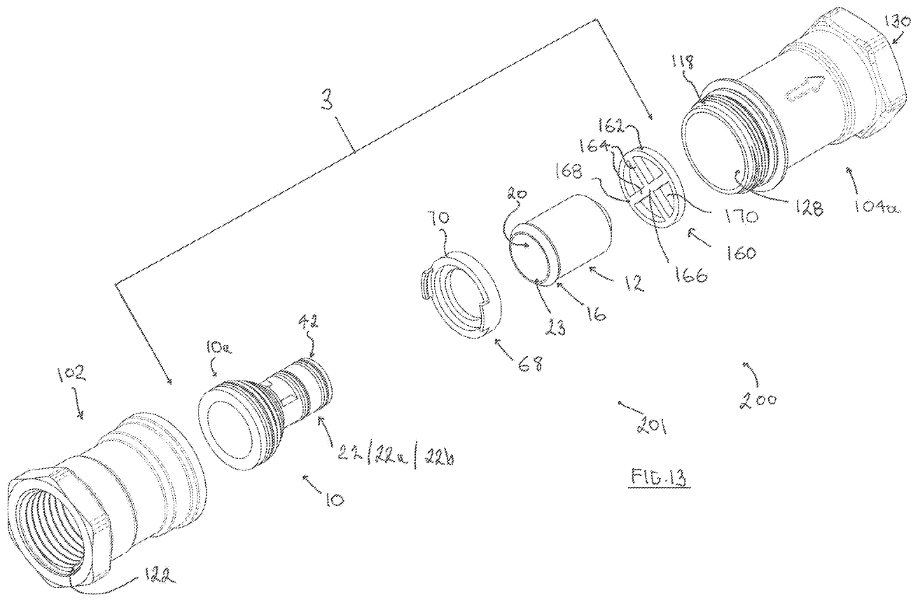

In FIG. 11, the piston 12 is shown in a slightly open position. In the slightly open position, the seating surface 30 has just started to move away from the valve seat 14 such that a slight gap, or spacing, has formed between the seating surface 30 and the valve seat 14 such that fluid is able to commence to flow from the fluid supply via the flow-way through the first opening 122 and the passage 126 of the first body section 102, through the first opening 34 and the passage 36 of the valve cartridge 2, through the second opening 38 and the openings 46, past the valve seat 14, into the second body section 104 and the passage 132 and out through the second opening 130 of the second body section 104. The flow of the fluid is represented by the arrows in FIG. 11.

In FIG. 12, the piston 12 is shown in the open (first) position, i.e. open condition of the valve cartridge 2 and the valve 100. In this position, the piston 12 is at its maximum spacing from the valve seat 14 and the maximum volume of fluid, as permitted by the valve 100, is able to flow through the valve 100 via the flow-way as herein before described with reference to FIG. 11. The flow of the fluid is represented by the arrows in FIG. 12.

As herein before described, the valve 100 operates as a pressure limiting valve. Accordingly, the valve 100 limits the downstream pressure to the set pressure of the valve 100.

When all taps, faucets, appliances and other outlet devices in the plumbing installation that are downstream of the valve 100 are closed, no fluid passes through the valve 100. The valve 100 is in the closed condition and the piston is in the second (closed) position. This is shown in FIG. 10.

The pressure and forces acting on the piston 12 can be summarised as follows. The outlet pressure P₂ (i.e. the fluid pressure, from the fluid in the plumbing installation, that acts on the outlet side of the seal 14) acts on external surfaces (i.e. the end wall 24 and the bevelled edge 28) of the piston 12 to move the piston 12 to the second (closed) position. This is represented by the dashed line P₂ in FIG. 10. The spring 93 and the compressed air in the internal space confined by the piston 12 and piston support 22 exert a spring force F_{S} and pressure P_{C}, respectively, that act on internal surfaces of the end wall 24 of the piston 12. This is represented by the dotted line FP inside the piston 12 in FIG. 10. The outlet pressure P₂ is greater than the spring force F_{S} and pressure P_{C}. The piston 12 is subjected to sufficient pressure (i.e. the outlet pressure P₂) to counter the bias acting on the piston 12 that biases the piston 12 away from the valve seat 14. Consequently, the piston 12 is forced to the second (closed) position by the outlet pressure P₂ and the valve 100 is in the closed condition.

The condition when the valve 100 is closed (i.e. no fluid flow through the valve 100) or when there is very low fluid flow (i.e. P₁≈P₂) through the valve 100 and before the seating surface 30 contacts the seal 14, can be expressed by the following equilibrium equation:

$$0 = {F}_{S} + \frac{π {D}^{2}}{4} ( {P}_{C} - {P}_{2} )$$

where:

P₁ is the pressure on the inlet side of the seal 14

P₂ is the pressure on the outlet side of the seal 14

P_{C} is the pressure exerted by the compressed air in the internal space confined by the piston 12 and piston support 22

D is the internal diameter of the piston 12

F_{S} is the spring force of the spring 93.

FIG. 11 shows the initial moments when a tap, faucet, appliance or other outlet device, in the plumbing installation, that is downstream of the valve 100 is opened, the outlet pressure P₂ starts to decrease. Due to this decrease in the outlet pressure P₂, the outlet pressure P₂ is no longer strong enough to force the piston 12 to the second (closed) condition in which the seating surface 30 abuts the seal 14. As the piston 12 moves along the piston support 22 in the direction toward the outlet side, i.e. away from the seal 14, the spring 93 and the air in the internal space confined by the piston 12 and piston support 22 become less compressed. Consequently, their biasing force that acts to move the piston 12 away from the valve seat 14 to open the valve 100 is reduced. The piston 12 finds a new equilibrium. The fluid is able to flow from the fluid supply line through the first opening 122 and the passage 126 of the first body section 102, through the first opening 34 and the passage 36 of the valve cartridge 2, through the second opening 38 and the openings 46, past the valve seat 14, into the second body section 104 and the passage 132 and out through the second opening 130 of the second body section 104. The flow of the fluid is represented by the arrows in FIG. 11.

FIG. 12 shows the valve 100 in the fully open condition. The piston 12 is in the first (open) position. The tap, faucet, appliance or other outlet device has been opened and the fluid pressure downstream, i.e. the outlet pressure P₂, is unable to build up appreciably. The spring force F_{S} exerted by the spring 93 and the pressure P_{C} of the compressed air in the internal space confined by the piston 12 and piston support 22 are sufficiently strong to move the piston 12 to the first position, i.e. its fully open position. Fluid is able to freely flow through the valve cartridge 2 and the valve 100, and this represents the set pressure of the valve 100 and the valve cartridge 2. The flow of the fluid is represented by the arrows in FIG. 12.

The set pressure (or set maximum pressure) of the valve 100 indicates the maximum pressure, as measured at the outlet, i.e. the opening 130, at which fluid is able to flow through the valve 100.

The set pressure is set at the time of manufacture of the valve cartridge 1/1A/1B/2. In the case of a valve cartridge 2, this is most readily done by selecting a spring 93 with a suitable spring force F_{S} to achieve the required set pressure for the valve cartridge 2 and the valve 100. For example, a spring 93 with a relatively higher spring force F_{S} would be selected to achieve a higher set pressure; conversely, a spring with a lower spring force F_{S} would be selected to achieve a lower set pressure.

The valve 100, shown in FIGS. 10-12, may have a valve cartridge 1, 1A or 1B of the first, second or third embodiments instead of the valve cartridge 2 of the fourth embodiment. In the case of the first, second and third embodiments of the valve cartridge 1/1A/1B, which do not have a spring 93, the use and operation of a valve cartridge 1/1A/1B in a valve 100 is the same as herein before described with reference to the valve cartridge 2, except that the biasing action of the piston 12 to the first (open) position is provided solely by the compressed air in the internal confined space that is confined by the piston 12 and piston support 22.

In the case of valve cartridges 1/1A/1B, the set pressure is determined by the pressure of the compressed air in the internal space confined by the piston 12 and piston support 22 when the piston 12 is in the second (closed) position. How high the set pressure is will be determined by how much smaller the maximum, i.e. final, volume V₂ is in relative to the initial volume V₁, as herein before described with reference to FIGS. 5A and 5B.

In the case of valve cartridges 1, 1A and 1B, the set pressure is determined by the pressure of the compressed air in the internal confined space that is confined by the piston 12 and piston support 22 when the piston 12 is in the second (closed) position.

In the valve cartridges 1A and 1B, the initial volume V′₁ and the final volume V′₂ are both made up of only the internal space 20 of the piston 12 or a portion of the internal space 20, respectively.

Since the valve cartridges 1/1A/1B do not have a spring 93, the set pressure cannot be set by selecting a spring 93 with a suitable spring force F_{S}. However, the set pressure can be selected by varying some of the structural parameters of the valve cartridge 1.

Firstly, the piston 12 may be made longer. In a longer piston 12, the internal space confined by the piston 12 and piston support 22 has an increased volume. An increased volume means that V₂/V₁ (V′₁/V′₂) in the case of valve cartridges 1A and 1B)) is larger and consequently leads to lower pressure, i.e. the resulting lower compression means that the set pressure is lower.

Secondly, the piston 12 may be made shorter. In a shorter piston 12, the internal space confined by the piston 12 and piston support 22 has a decreased volume. A decreased volume means that V₂/V₁ (V′₁/V′₂) is smaller and consequently leads to higher pressure, i.e. the resulting higher compression means that the set pressure is higher.

Thirdly, placing an incompressible object, i.e. an insert, into the internal space 20 in the piston 12 or the internal space 52 in the piston support 22. Such an insert decreases the volume of the internal space 20/52 in which it is placed. A decreased volume means that V₂/V₁ (V′₁/V′₂) is smaller and consequently leads to higher pressure, i.e. the resulting higher compression means that the set pressure is higher.

Fourthly, the first seal 56 may be relocated on the external surface 58 of the piston support 22. In particular, the seal 56 may be relocated such that it is further from the first end 42 of the piston support 22. This results in the air in the internal space confined by the piston 12 and piston support 22 not being compressed as much. Consequently, V₂/V₁ (V′₁/V′₂) is larger and consequently leads to lower pressure, i.e. the resulting lower compression means that the set pressure is lower.

Varying one or more of these parameters may be used to obtain the desired set pressure of the valve cartridge 1/1A/1B and a valve that incorporates the valve cartridge 1.

Furthermore, one or more of these parameters may be varied to obtain the desired set pressure in a valve cartridge 2 of the fourth embodiment. However, since obtaining the desired set pressure is more readily achieved by selecting a spring 93 with a suitable spring force F_{S}, that is usually the way the desired set pressure is obtained for a valve cartridge 2 of the fourth embodiment.

Valve Cartridge Kit. Drop-In Piston Stop

The valve cartridges 1, 1A, 1B and 2 of the first, second, third and fourth embodiments herein before described each have a piston retainer 83 to retain the piston 12 on the piston support 22/22a/22b. However, in a valve cartridge kit in accordance with another aspect of the present invention, the piston retainer 83 is omitted.

In that regard, in FIG. 13 there is shown an exploded view of another embodiment of a valve 200 that includes a first embodiment of a valve cartridge kit 3 (i.e. a valve cartridge kit of components) in accordance with another aspect of the present invention. The valve cartridge kit 3 can be used to assemble a valve 200, with the valve cartridge kit of components installed in a valve 200.

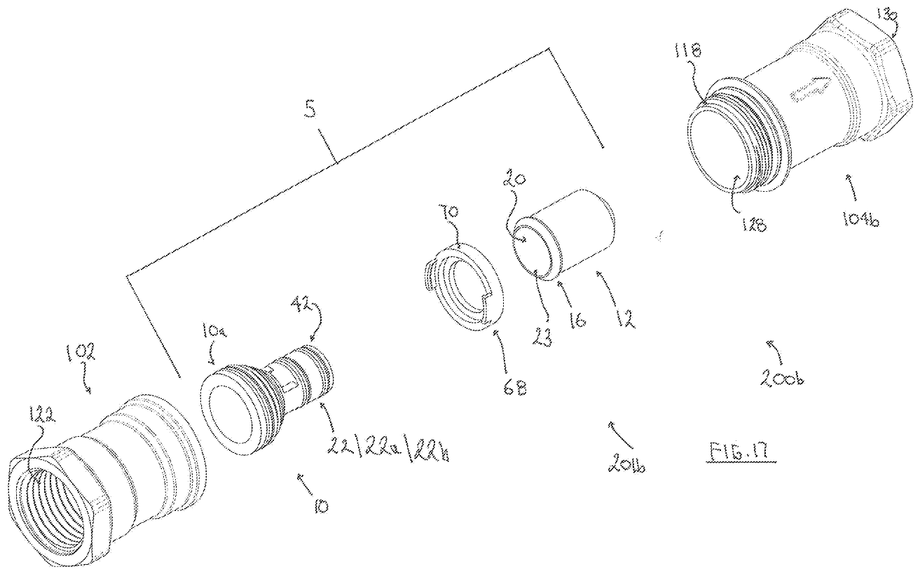

The valve 200 comprises a valve body 201 and a valve cartridge kit 3. The valve body 201 comprises a first body section, or part, 102 and a second body section, or part, 104a. The first body section 102 is the same as the first body section 102 of the valve 100, and will not be again described. The second body section 104a has a modification in that the second body portion 104a is provided with a shoulder 146a instead of the shoulder 146 of the second body portion 104 of the embodiments herein before described. (The shoulder 146a is shown in FIGS. 15 and 16.) The shoulder 146a is located inside the passage 132. The shoulder 146a extends from the wall 148 of the second body section 104a. The shoulder 146 is substantially annular. However, the shoulder 146a does not have a bevelled face 150.

The valve cartridge kit 3 is made up of separate components that are unconnected and can be assembled in the first and second body sections 102 and 104 to form the valve 200.

The valve cartridge kit 3 comprises a body 10, a piston 12 and a piston support 22/22a/22b. The body 10, piston 12 and piston support 22/22a/22b are the same as the body 10, piston 12 and piston support 22/22a/22b of the valve cartridges 1/1A/1B/2, and will not be again described. The body 10 and piston 12 are unconnected (i.e. separate) components of the valve cartridge kit 3. They are installed separately in the first and second body sections 102 and 104a to form the valve 200.

The valve cartridge kit 3 further comprises a valve seat retainer 68 to retain the valve seat 14 in position. The valve seat retainer 68 is similar to the valve seat retainer 68 of the valve cartridges 1, 1A, 1B and 2 of the first, second, third and fourth embodiments. However, as the valve cartridge kit 3 does not have a piston retainer (83), there are no lugs 84 extending from the second face 86 of the ring 70. The valve seat retainer 68 is shown spaced from the body 10 in FIG. 13 because FIG. 13 is an exploded view. However, the valve seat retainer 68 normally is attached to the body 10, as herein before described with reference to the valve cartridge 1 of the first embodiment. Thus, the body 10 and valve seat retainer 68 may form a single component of the valve cartridge kit 3.

The valve cartridge kit 3 further comprises a piston stop 160. The piston stop 160 comprises a ring 162 with a pair of diametral supports 164 extending between opposed locations on the ring 162. The diametral supports 164 intersect at a central hub 166. The piston stop 160 is substantially flat and disc-like with a pair of flat opposed faces 168. The piston stop 160 is provided with four openings 170 formed by the ring 162 and the diametral supports 164.

The components of the valve cartridge kit 3 are separate and are installed in the first and second body parts 102 and 104a at the time of assembly of the valve 200. The method of assembling the valve 200 comprises installing the components of the valve cartridge kit 3 in the first and second body parts 102 and 104a such that they are positioned in sequence in the direction from the (inlet) opening 122 to the (outlet) opening 130 in the following order: the body 10 (with the piston support 22), the piston 12, and the piston stop 160. The first and second body sections 102 and 104a are attached together via their respective screw threads 110 and 118 to complete the assembly of the valve 200.

Conveniently, the method of assembling the valve 200 comprises first inserting the components of the valve cartridge kit 3 into the second body section 104a via the first opening 128. The components are inserted in sequence, i.e. sequentially. In that regard, the piston stop 160 is inserted into the second body section 104a such that the ring 162 abuts the shoulder 146a. A first face 170 of the piston stop 160 contacts the shoulder 146a. Next, the piston 12 is inserted into the second body section 104a (with the second end 18 of the piston 12 inserted first). Next, the body 10, with the valve seat retainer 68 attached thereto, is inserted into the second body section 104a, such that at least a portion of the piston support 22/22a/22b is received in the internal space 20 of the piston 12 (i.e. such that the first end 42 of the piston support 22/22a/22b is inserted into the piston 12 via the opening 23 at first end 16 of the piston 12). The first and second body sections 102 and 104a are attached together via their respective screw threads 110 and 118 to complete the assembly of the valve 200. Accordingly, the valve cartridge kit 3 is retained in the body 201 of the valve 200.

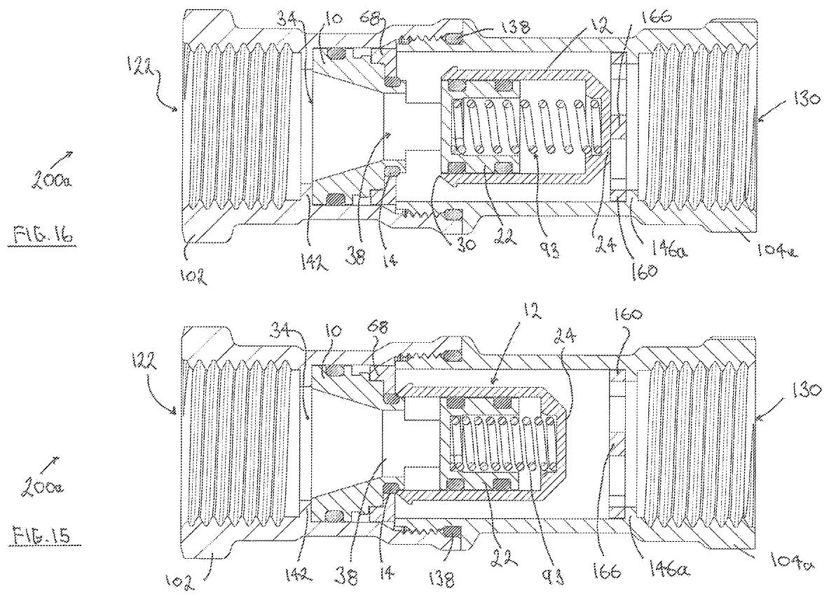

In FIG. 14, there is shown an exploded view of another embodiment of a valve 200a that includes a second embodiment of a valve cartridge kit 4 in accordance with another aspect of the present invention. The valve 200a comprises a valve body 201a and a valve cartridge kit 4. The valve body 201a comprises a first body section, or part, 102 and a second body section, or part, 104a.

The valve cartridge kit 4 of the second embodiment is similar to the valve cartridge kit 3 of the first embodiment, except that the valve cartridge kit 4 further comprises a spring 93. The inclusion of a spring 93 has been herein before described with reference to the valve cartridge 2, and will not be again described.

The method of assembling the valve 200a (that includes the valve cartridge kit 4 of the second embodiment) is similar to the method of assembling the valve 200 (that includes the valve cartridge kit 3 of the first embodiment), except that it further comprises inserting the spring 93 into the internal space 20 of the piston 12, which has been positioned in the second body section 104a, prior to the body 10 being inserted into the second body portion 104a. Accordingly, the valve cartridge kit 4 is retained in the body 201a of the valve 200a.

In other respects, the valve cartridge kit 4 of the second embodiment is the same as the valve cartridge kit 3 of the first embodiment.

FIGS. 15 and 16 show the valve 200a in closed and open conditions, respectively. FIGS. 15 and 16 correspond to FIGS. 10 and 12 that show the valve 100. In FIG. 15, the piston 12 is spaced from the piston stop 160 and the piston 12 seats on the valve seat 14. In FIG. 16, the valve 200a is in the fully open condition with the piston 12 in the first (open) position. In this position of the piston 12, the piston 12 abuts the piston stop 160. The end wall 24 of the piston 12 abuts the piston stop 160. The end wall 24 contacts the diametral supports 164 and the central hub 166. This prevents, i.e. stops, any further movement of the piston 12 in the direction toward the outlet opening i.e. the second opening 130, of the valve 200a. The piston stop 160 also ensures that the piston 12 is retained with the piston support 22 in the valve 200a.

The preceding description of the valve 200a with reference to FIGS. 15 and 16 also applies to the valve 200, except that the valve cartridge kit 3 of the valve 200 does not have a spring 93.

The use and operation of the valves 200 and 200a is the same as herein before described with reference to the valve 100 and will not be again described.

Valve Cartridge Kit. Built-In Piston Stop

The valve cartridge kits 3 and 4 of the first and second embodiments herein before described each have a piston stop 160. However, in a valve cartridge kit in accordance with another aspect of the present invention, the piston stop 160 is omitted from the valve cartridge kit. Instead, a piston stop is incorporated in the second body section.

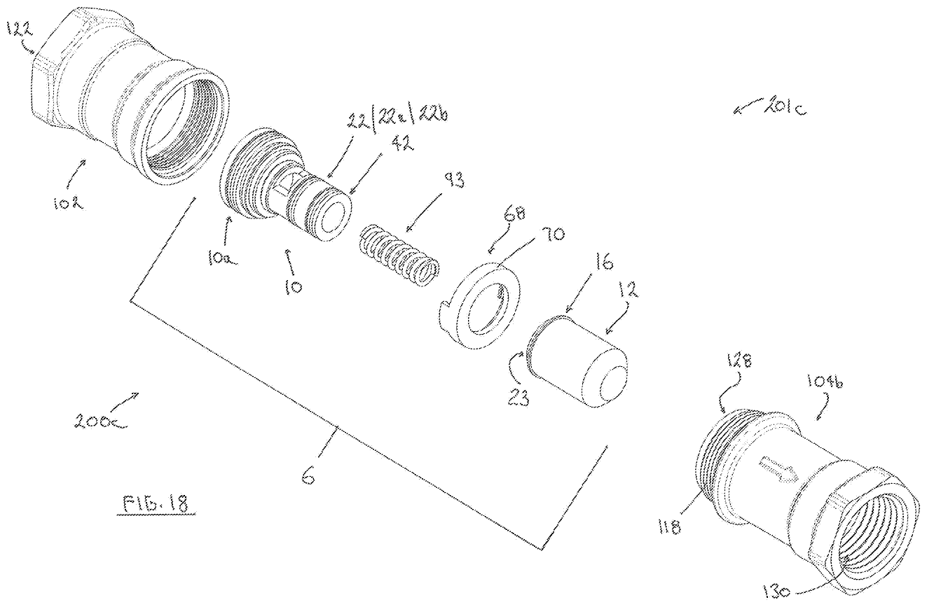

In FIG. 17, there is shown an exploded view of another embodiment of a valve 200b that includes a third embodiment of a valve cartridge kit 5 (i.e. a valve cartridge kit of components) in accordance with another aspect of the present invention. The kit of components can be used to assembly a valve cartridge that can be installed in a valve.

The valve cartridge kit 5 does not have a piston stop 160. In other respects, the valve cartridge kit 5 of the third embodiment is the same as the valve cartridge kit 3 of the first embodiment.

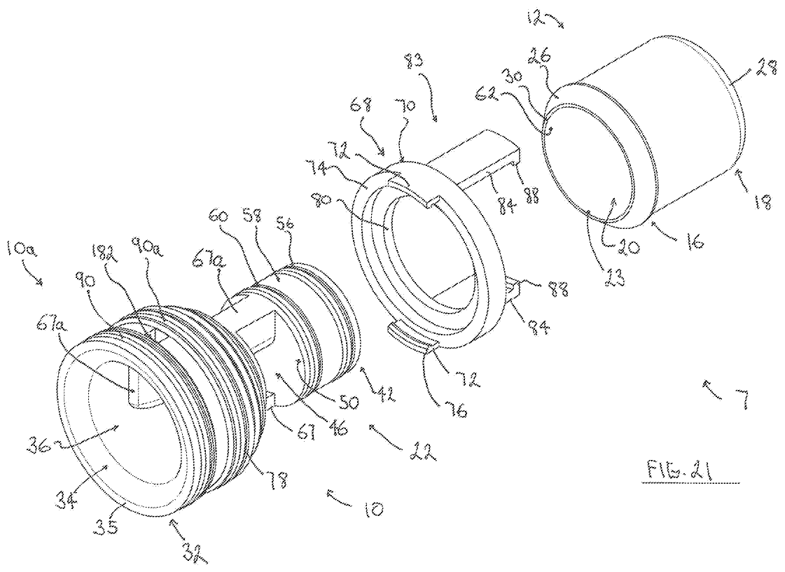

The valve 200b comprises a valve body 201b and a valve cartridge kit 5. The valve body 201b comprises a first body section, or part, 102 and a second body section, or part, 104b. The first body section 102 is the same as the first body section 102 of the valve 100, and will not be again described. The second body section 104b has a modification in that the second body portion 104b is provided with a piston stop 160a, as is further described with reference to FIGS. 19 and 20.

The method of assembling the valve 200b (that includes the valve cartridge kit 5 of the third embodiment) is similar to the method of assembling the valve 200 (that includes the valve cartridge kit 3 of the first embodiment), except that no piston stop 160 is inserted into the second body portion 104b since the valve cartridge kit 5 does not have a piston stop 160. Accordingly, the valve cartridge kit 5 is retained in the body 201b of the valve 200b.

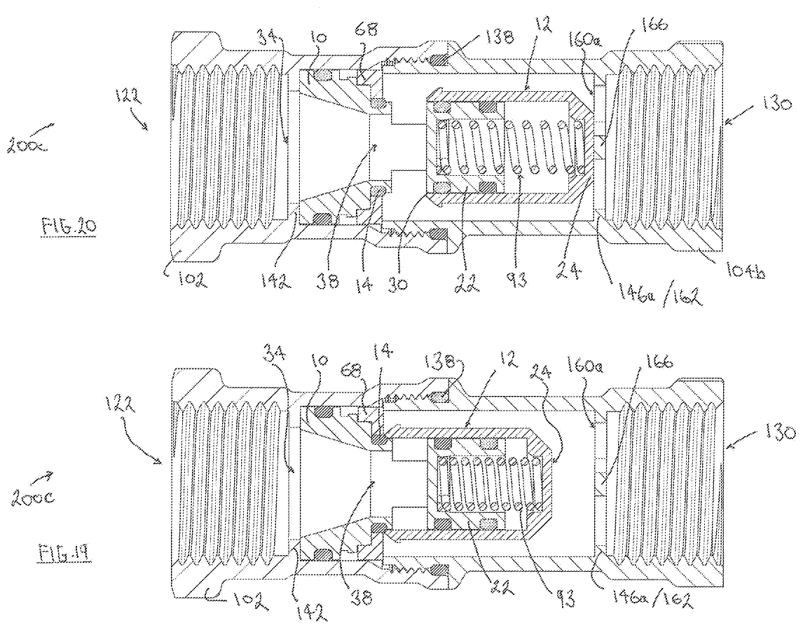

In FIG. 18, there is shown an exploded view of another embodiment of a valve 200c that includes a fourth embodiment of a valve cartridge kit 6 in accordance with another aspect of the present invention. The valve 200c comprises a valve body 201c and a valve cartridge kit 5. The valve body 201c comprises a first body section, or part, 102 and a second body section, or part, 104b.

The valve cartridge kit 6 of the fourth embodiment is similar to the valve cartridge kit 5 of the third embodiment, except that the valve cartridge 6 further comprises a spring 93. The inclusion of a spring 93 has been herein before described with reference to the valve cartridge 2, and will not be again described. In other respects, the valve cartridge kit 6 of the fourth embodiment is the same as the valve cartridge kit 5 of the third embodiment.

The method of assembling the valve 200c (that includes the valve cartridge kit 6 of the fourth embodiment) is similar to the method of assembling the valve 200b (that includes the valve cartridge kit 5 of the third embodiment), except that it further comprises inserting the spring 93 into the internal space 20 of the piston 12, which has been positioned in the second body section 104b, prior to the body 10 being inserted into the second body portion 104a. Accordingly, the valve cartridge kit 5 is retained in the body 201c of the valve 200c.

FIGS. 19 and 20 show the valve 200c in closed and open conditions, respectively. FIGS. 19 and 20 correspond to FIGS. 10 and 12, which show the valve 100, and to FIGS. 15 and 16, which show the valve 200a.

The piston stop 160a can be seen in FIGS. 19 and 20. The piston stop 160a may be of similar structure to the piston stop 160 of the valve cartridge kits 3 and 4, except that the piston stop 160a is provided as a built-in part of the second body portion 104b, i.e. the piston stop 160a is formed integrally with the second body section 104b. The piston stop 160a may be provided in the second body section 104b such that the shoulder 146a forms the ring 162 of the piston stop 160a the pair of diametral supports 164 extend between opposed locations on the ring 162/shoulder 146a.

In FIG. 19, the piston 12 is spaced from the piston stop 160a and the piston 12 seats on the valve seat 14. In FIG. 20, the valve 200c is in the fully open condition with the piston 12 in the first (open) position. In this position of the piston 12, the piston 12 abuts the piston stop 160a. The end wall 24 of the piston 12 abuts the piston stop 160a. The end wall 24 contacts the diametral supports 164 and the central hub 166. This prevents, i.e. stops, any further movement of the piston 12 in the direction toward the outlet opening i.e. the second opening 130, of the valve 200c. The piston stop 160a also ensures that the piston 12 is retained with the piston support 22 in the valve 200c.

The preceding description of the valve 200c with reference to FIGS. 19 and 20 also applies to the valve 200b, except that the valve cartridge kit 5 of the valve 200b does not have a spring 93.

The use and operation of the valves 200b and 200c is the same as herein before described with reference to the valve 100 and will not be again described.

Embodiments with Adjustable Set Pressure

As herein before described under the section headed “USE”, in the embodiments of the valve cartridge 1/1A/1B/2, the set pressure is set at the time of manufacture of the valve cartridge. Thus, in these embodiments of the valve cartridge, the set pressure is fixed. Accordingly, the set pressure of the embodiments of the valve cartridge 1/1A/1B/2 cannot be adjusted, or altered, after assembly of the valve cartridge 1/1A/1B/2.

However, in alternative embodiments, the valve cartridge and valve cartridge kit may be provided such that the set pressure is adjustable after the valve cartridge, or valve cartridge kit, is incorporated in, or installed in, a valve. Embodiments of such valve cartridges, valve cartridge kits and valves are described in the following sections.

### Air Only

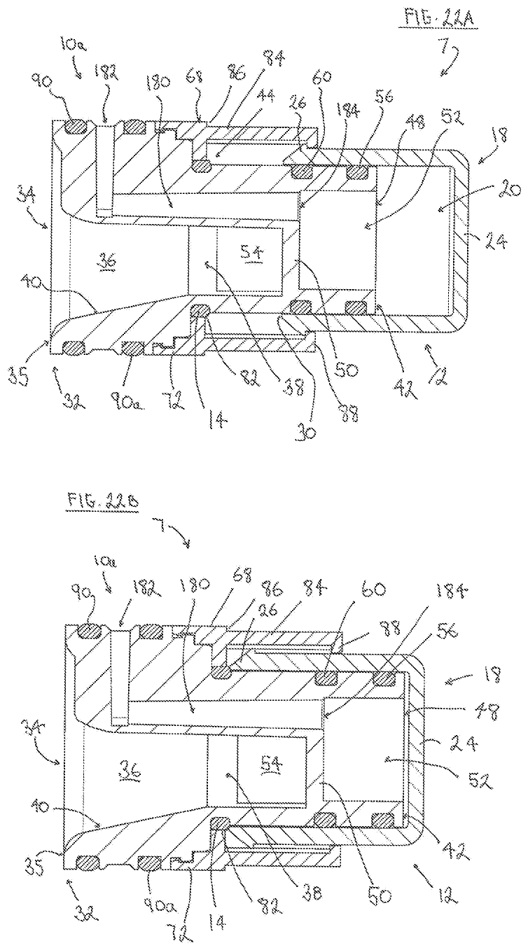

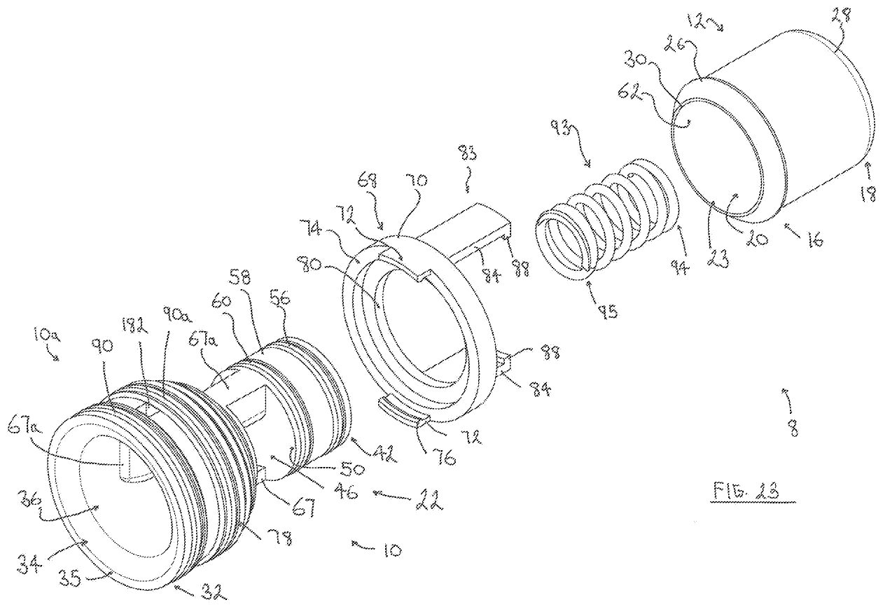

In FIGS. 21, 22A and 22B, there is shown a fifth embodiment of a cartridge 7 for a valve (also referred to herein as a valve cartridge 7).

FIG. 22A shows the valve cartridge 7 in the fully open condition. In this condition (as is the case in the other embodiments described herein when the valve cartridge is in the open condition), the piston 12 is in the first (open) position. FIG. 22B shows the valve cartridge 7 in the closed condition. In this condition (as is the case in the other embodiments described herein when the valve cartridge is in the closed condition), the piston 12 is in the second (closed) position.

The valve cartridge 7 of the fifth embodiment is substantially similar to the valve cartridge 1 of the first embodiment; however, the valve cartridge 7 is provided with a passage 180 and an additional seal 90a on the sealing body portion 10a. The passage 180 extends from an opening 182 in the body 10 of the valve cartridge 7 to an opening 184 in the wall 50 of the piston support 22. The opening 182 is located at the outer surface of the sealing body portion 10a. The opening 184 is located at the surface of the wall 50 inside the internal space 52 of the piston support 22. The opening 182 is in communication with the exterior of the valve cartridge 7. The opening 184 is in communication with the internal space 52 of the piston support 22. The opening 182 is located between the seals 90 and 90a at the outer surface of the body 10; in particular, on the sealing body portion 10a. The seal 90a, which is positioned on the sealing body portion 10a, is in fluid-tight abutment with the inside surface of the body. The seal 90a thereby forms a seal between the sealing body portion 10a of the valve cartridge 7/8 and the second body section 310.

To accommodate the passage 180, one of the portions 67 that extend from the sealing body portion 10a to the wall 50 is enlarged (identified as portion 67a in the drawings) and the portion 67a also extends into the passage 36. The passage 180 extends from the opening 182, through the sealing body portion 10a and the portion 67a to the opening 184. The exterior of the body 10 of the valve cartridge 7 is in communication with the space 52 inside the piston support 22 via the passage 180.

In this way, the passage 180 forms a pressure adjustment passage of the valve cartridge 7.

### Spring Included

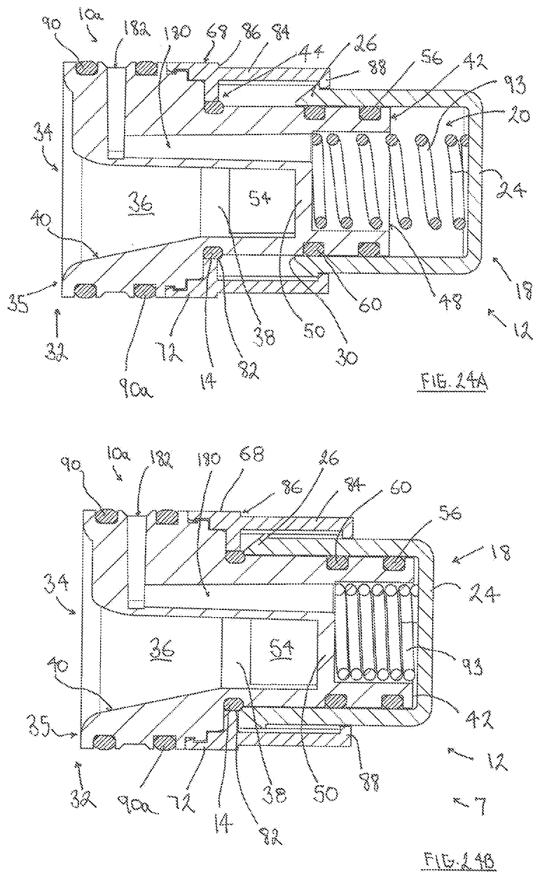

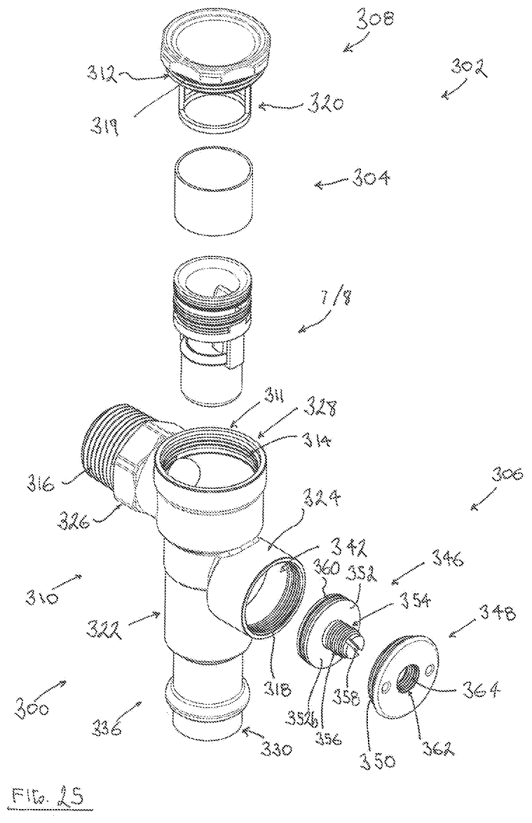

In FIGS. 23, 24A and 24B, there is shown a sixth embodiment of a cartridge 8 for a valve (also referred to herein as a valve cartridge 8).

The valve cartridge 8 of the sixth embodiment is similar to the valve cartridge 7 of the fifth embodiment, except that the valve cartridge 8 further comprises a spring 93. The spring 93 is provided between the piston 12 and piston support 22. In particular, the spring 93 is provided in the internal space confined by the piston 12 and the piston support 22. A first end 94 of the spring 93 abuts the end wall 24 of the piston 12 and a second end 95 of the spring 93 abuts the wall 50 inside the piston support 22. The first and second ends 94 and 95 of the spring 93 are best seen in FIG. 23. The first and second ends 94 and 95 are also labelled in FIG. 27.

As in the fourth embodiment of the valve cartridge 2 (shown in FIG. 7), the spring 93 provides additional biasing force (i.e. in addition to the biasing force of the compressed air in the internal space confined by the piston 12 and the piston support 22 as herein before described) to bias the piston 12 away from the valve seat 14 to the open (first) position. The greater the spring force of the spring 93, the greater will be the biasing force that it imparts on the piston 12. Accordingly, the valve cartridge 8 of the sixth embodiment is suitable for applications in which greater biasing force is required than can be provided by only the compressed air in the internal space confined by the piston 12 and the piston support 22.

The embodiments of the valve cartridges 7 and 8 that provide for the set pressure to be adjustable are of a larger size than the embodiments of the valve cartridges 1/1A/1B/2 that have a fixed set pressure. This is because the sealing body portion l0a is of a larger size to accommodate the additional seal 90a and the passage 180 which extends through the sealing body portion l0a and the portion 67a, which also is of a larger size than the portions 67 of the valve cartridges 1/1A/1B/2. This results in the sealing body portion 10a of the valve cartridges 7 and 8 being longer in length than the sealing body portion 10a of the valve cartridges 1/1A/1B/2. The sealing body portion 10a and the piston support 22 of the valve cartridges 7/8 may have external diameters similar to the piston 12 and piston support 22 of the valve cartridges 1/1A/1B/2. However, for valve cartridges 1/1A/1B/2 and valve cartridges 7/8 that have similar external diameters, a valve incorporating a valve cartridge 7/8 typically would have a higher pressure drop (in the fluid) over the valve (i.e. between the inlet and the outlet of the valve) than a valve incorporating a valve cartridge 1/1A/1B/2. This is because the (enlarged) portion 67a extends into the passage 36 and to the first inlet end 32. This is best seen in FIGS. 22A, 22B, 24A and 24B. Consequently, due to this presence of the portion 67a, the cross sectional area available for fluid flow in the valve cartridges 7/8 is less than the cross sectional area available for fluid flow in the valve cartridges 1/1A/1B/2 at their respective first (inlet) ends 32. Therefore, to achieve the same pressure drop over the valve that a particular valve cartridge 1/1A/1B/2 would achieve, a valve cartridge 7/8 is made with a greater external diameter. In particular, the sealing body portion 10a and the piston support 22 of such a valve cartridge 7/8 are provided with greater external diameters than the piston 12 and piston support 22 of a valve cartridge 1/1A/1B/2 having the same pressure drop when installed in a valve.

### Valve Incorporating a Pressure-Adjustable Valve Cartridge

A valve cartridge 7 or 8 (valve cartridge 7/8) of the fifth or sixth embodiments may be provided in a valve. In particular, the valve cartridge 7/8 may be a component or part of a valve, such as a pressure control valve, in particular a pressure limiting valve (also referred to as a “pressure reducing valve” in the art) or a valve that incorporates a pressure limiting valve. The nature and function of a pressure limiting valve has been herein before described.

The set pressure of a valve incorporating a valve cartridge 7/8 may be adjusted after assembly of the valve.

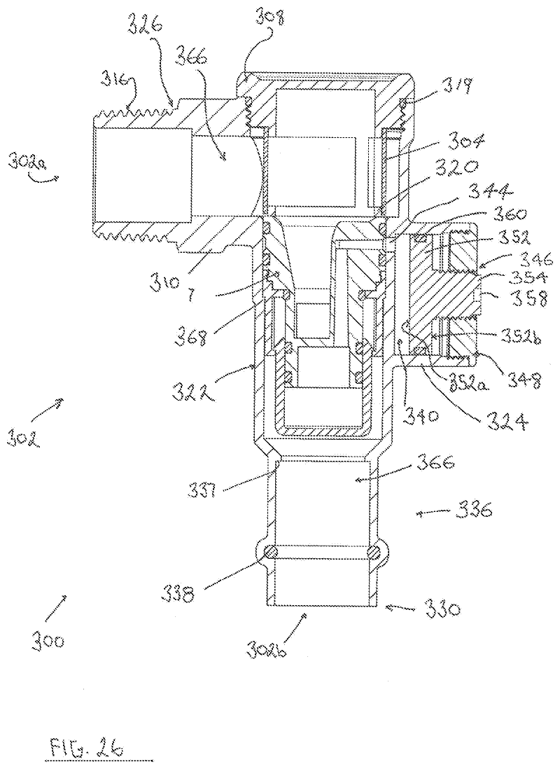

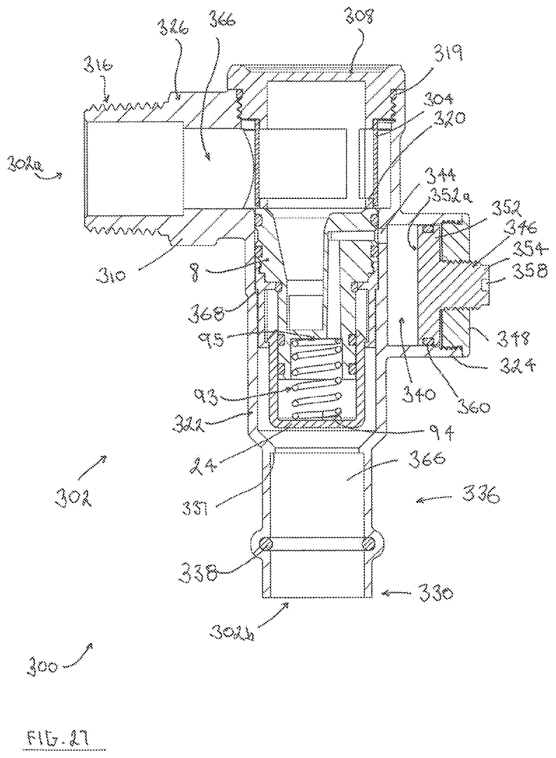

FIG. 25 is an exploded view of an embodiment of a valve 300 that may include a valve cartridge 7 or a valve cartridge 8, as herein before described. FIG. 26 is a cross sectional view of the valve 300 when it includes a valve cartridge 7 (i.e. no spring 93 is included). FIG. 27 is a cross sectional view of the valve 300 when it includes a valve cartridge 8 (i.e. spring 93 is included).

In FIG. 25, there is shown an embodiment of a valve 300 comprising a valve body 302, a valve cartridge 7/8, a strainer 304 and a set pressure adjuster 306. The set pressure adjuster 306 can be used to adjust the set pressure of the valve 300, as is further described herein. The valve body 302 has an inlet and an outlet, which form the inlet and outlet, respectively, of the valve 300. The inlet and outlet are formed by first and second openings 302a and 302b, respectively, of the valve body 302. The openings 302a and 302b are best seen in FIGS. 26 and 27. The valve body 302 comprises a first body section, or part, 308 and a second body section, or part, 310. The second body section 310 is provided with the first and second openings 302a and 302b of the body 302. Only some of the parts of the valve cartridge 7/8 have been identified by reference numbers in FIG. 25 and also in FIGS. 26 and 27, which are further described herein. However, reference may be made to FIGS. 21 to 24B to identify the reference numbers for the other parts of the valve cartridge 7/8.

The first and second body sections 308 and 310 are detachably connected together. The body sections 308 and 310 may be connected together with the valve cartridge 7/8 retained in the body 302 during assembly of the valve 300. In particular, the valve cartridge 7/8 is positioned inside the second body section 310 of the body 302. In the event that the valve cartridge 7/8 requires maintenance or replacement, the body sections 308 and 310 can be detached to allow access to the valve cartridge 7/8 for maintenance or replacement. Once maintenance or replacement of the valve cartridge 7/8 has been performed, a valve cartridge 7/8 can be reinstalled in position and the body sections 308 and 310 can be reconnected together.

The second body section 310 is the main section of the body 302. The second body section 310 is provided with connection fittings to enable the valve 300 to be connected into a plumbing installation. The connection fittings may be of any suitable type, e.g. screw threads, press-fitting. By way of example, in the embodiment of the valve 300 described herein and shown in the drawings, two different types of connection fittings are provided. In that regard, a first connection fitting is provided as a screw thread 316 and a second connection fitting is provided as a press fitting 336, as will be further described herein. The first body section 308 is in the form of an end cap, or closure. The first body section 308 closes an opening 311 of the second body section 310. The valve cartridge 7/8 and strainer 304 are inserted into the second body section 310 via the opening 311 during assembly of the valve 300. The first body section 308 is provided with a screw thread 312. The second body section 310 is provided with first, second and third screw threads 314, 316 and 318, respectively.

The first body section 308 is provided with a seal. The seal may be an O-ring 319. The first body section 308 is provided with a support frame 320 to support the strainer 304. The strainer 304 is cylindrical in shape. The strainer 304 comprises a mesh material that allows fluid to flow therethrough whilst preventing passage of debris. The support frame 320 locates inside the strainer 304 in the assembled condition of the valve 300. In the assembled condition of the valve 300, the valve cartridge 7/8 and strainer 304 are positioned in the second body section 310; in addition, the first body section 308 is connected to the second body section 310; furthermore, the first body section 308 closes the opening 311. The O-ring 319 provides a fluid tight seal between the first and second body sections 308 and 310. This fluid tight seal prevents escape of fluid from inside the valve 300 through the connection between the first and second body sections 308 and 310. The first body section 308 and the second body section 310 are connected together via their respective screw threads 312 and 314. The screw threads 312 and 314 are engaged to attach the first and second body sections 308 and 310 together. The screw threads 312 and 314 are best seen in FIG. 25. The engagement of the screw threads 312 and 314 is best seen in FIGS. 26 and 27, which show the first and second body sections 308 and 310 connected together.

The second body section 310 comprises a first portion 322, a first offset portion 324 and a second offset portion 326. The first offset portion 324 and second offset portion 326 extend from the first portion 322 in an offset manner relative to the longitudinal axis of the first portion 322. The first and second offset portions 324 and 326 are spaced apart from each other along the longitudinal axis of the first portion 322. The first and second offset portions 324 and 326 are located on opposed sides of the first portion 322, i.e. they are positioned substantially 180° apart around the first portion 322.

The first portion 322 is substantially cylindrical in shape. The first portion 322 has a first end 328 and a second end 330. The first portion 322 is provided with the opening 311. The opening 311 is provided at the first end 328 of the first portion 322. The first portion 322 is provided with the second opening 302b. The second opening 302b of the body 302 is provided at the second end 330 of the first portion 322 of the second body section 310. The first portion 322 is provided with the screw thread 314. The screw thread 314 is provided adjacent the first end 328 of the first portion 322. The screw thread 314 is provided adjacent the opening 311.

The second body section 310 is provided with a connection fitting in the form of a press fitting 336. The press fitting 336 is provided near or adjacent to the second end 330 of the first portion 322. The press fitting 336 comprises a straight section, which extends between an internal annular shoulder 337 (inside the first portion 322), and the second end 330. A seal, which may be in the form of an O-ring 338, is provided in the straight section.

The first offset portion 324 is a portion of the body 10 of the valve 300 that accommodates the set pressure adjuster 306. The first offset portion 324 may also be referred to as the adjuster offset portion 324. The set pressure adjuster 306 comprises a chamber 340. The volume of the chamber 340 may be varied. The chamber 340 is provided in the first offset portion 324, as is further described herein.

The first offset portion 324 has an opening 342. The opening 342 opens to the exterior of the valve 300. A hole 344 is provided in the wall of the second body section 310. The hole 344 extends through the wall of the second body section 310. The hole 344 extends through the wall of the second body section 310 at the first portion 322. The hole 344 extends between the chamber 340 and the interior of the second body section 310 of the valve 300. The hole 344 extends between the chamber 340 and the interior of the first portion 322 of the second body section 310. When the valve cartridge 7/8 is positioned inside the second body section 310 of the valve 300, the hole 344 and the opening 182 in the sealing body portion 10a are aligned. The chamber 340 is in communication with the opening 182 via the hole 344. The chamber 340 and the passage 180 are in communication via the hole 344 and the opening 180.

The set pressure adjuster 306 further comprises an adjustment screw 346. The adjustment screw 346 is retained by a cover 348. The cover 348 is attached to the first offset portion 324. The cover 348 closes the opening 342 of the first offset portion 324. The cover 348 may be removably attached to the first offset portion 324. The removable attachment may be by way of screw threads. In that regard, the cover 348 is provided with a screw thread 350 and the first offset portion 324 is provided with the screw thread 318. The screw threads 350 and 318 are engaged to attach the cover 348 to the first offset portion 324. The screw threads 350 and 318 are best seen in FIG. 25. The engagement of the screw threads 350 and 318 is best seen in FIGS. 26 and 27, which show the cover 348 attached to the first offset portion 324. The adjustment screw 346 comprises a disc 352 and a pin 354. The disc 352 has a first (i.e. inner) face 352a and a second (i.e. outer) face 352b. The pin 354 extends from the central region of the second face 352b of the disc 352. The pin 354 is provided with a screw thread 356 on its external surface. The pin 354 is provided with a slot 358 at its distal end, spaced from the disc 352. The disc 352 is provided with a seal at its outer edge. The seal may be an O-ring 360. The cover 348 is provided with a hole 362. The hole 362 is located centrally in the cover 348. The cover 348 is provided with a screw thread 364 around the hole 362. The screw thread 356 of the pin 354 engages with the screw thread 364 of the disc 352. The O-ring 360 seals against the inner surface of the first offset portion 324. The O-ring 360 provides a fluid tight seal between the cover 348 and the first offset portion 324. This fluid tight seal prevents escape of fluid from inside the chamber 340 through the connection between the cover 348 and the first offset portion 324. FIGS. 26 and 27 show the adjustment screw 346 engaged with the cover 348 and the cover 348 attached to the first offset portion 324. Compressible fluid is provided in the passage 180 and the chamber 340. The compressible fluid may comprise a gas or gas mixture. The gas or gas mixture may comprise air. However, as an alternative, the gas or gas mixture may be any suitable gas or gas mixture.

The chamber 340 extends between the first face 352a of the disc 352 and the exterior surface of the second body section 310 inside the first offset portion 324. The exterior surface of the second body section 310, to which the chamber 340 extends, is part of the first portion 322.

A passage 366 extends through the second body section 310 from the (inlet) opening 302a to the (outlet) opening 302b of the valve body 302. The cartridge 7/8 is positioned in the second body section 310. Fluid flowing through the valve body 302 from the (inlet) opening 302a to the (outlet) opening 302b must pass through cartridge 7/8.

The second body section 310 is provided with a shoulder 368. The shoulder 368 is annularly shaped. The shoulder 368 is located in the passage 366. The shoulder 368 is provided on the first portion 322.

When the valve 300 is in the assembled condition (as shown in FIGS. 26 and 27), the shoulder 368 abuts the second face 86 of the ring 70 of the valve seat retainer 140; in addition, a first (distal) end of the support frame 320 abuts the abutment surface 35 at the first end 32 of the body 10 of the valve cartridge 7/8. This clamps the valve cartridge 7/8 between the shoulder 368 and the first (distal) end of the support frame 320. Accordingly, when the valve 300 is in the assembled condition, the valve cartridge 7/8 is retained in the body 302 of the valve 300.

The screw thread 316 and the press fitting 336 may be used to connect the valve 300 into a plumbing installation. This is done in conventional manner, the screw thread 316 being connected with a complementary screw thread fitting and the press fitting 336 may be connected to a tube, e.g. a copper tube. In that regard, a tube may be pushed into the second opening 302b, past the O-ring 338, and until it abuts the shoulder 337, which acts as a stop. A press tool may then be used to deform the diameters of the valve body 302 (at the second body section 310) on the valve side of the O-ring 338 (the valve body 302 directly and the tube inside indirectly) so that the tube is then fixedly connected to the valve 300. As will be readily apparent to a person skilled in the art, alternative connection fittings may be provided, e.g. a screw thread may be used at the outlet opening 302b.

### Use

The use and operation of a valve cartridge 7/8 and a valve 300 will now be described.

The use and operation of the valve cartridge 7/8 and valve 300 is substantially the same as the use and operation of the corresponding embodiments of valve cartridges, valve cartridge kits and valves, herein before described. Accordingly, such use and operation that is common between the embodiments will not be again herein described. It will be understood that such use and operation applies mutatis mutandis to the valve cartridge 7/8 and the valve 300 with reference to the corresponding or analogous figures of the drawings of the valve cartridge 7/8 and the valve 300. Accordingly, the following description of the use and operation of the valve cartridge 7/8 and valve 300 is primarily directed to the set pressure adjustability of the valve 300 that is provided by the valve cartridge 7/8.

The set pressure adjuster 306 can be used to adjust the set pressure of the valve 300, when the valve 300 is installed in a plumbing installation, by rotating the adjustment screw 346.

In that regard, the slot 358 of the pin 354 may be engaged with a suitable tool (such as a screwdriver) to rotate the adjustment screw 346. When the adjustment screw 346 is rotated, it rotates relative to the cover 348. When the adjustment screw 346 is rotated in a first direction, the disc 352 moves away from the cover 348; this corresponds to movement of the disc 352 toward the second body section 310. When the adjustment screw 346 is rotated in a second direction, the disc 352 moves toward the cover 348; this corresponds to movement of the disc 352 away from the second body section 310.

When the adjustment screw 346 is rotated in the first direction, the volume of the chamber 340 (i.e. the volume between the first face 352a of the disc 352 and the exterior surface of the second body section 310 inside the first offset portion 324) decreases. When the adjustment screw 346 is rotated in the second direction, the volume of the chamber 340 increases.

The volume of the chamber 340 is at the maximum when the disc 352 is closest to the cover 348; this is also the position of the disc 352 when it is at the maximum spacing from the exterior surface of the second body section 310 inside the first offset portion 324. This position of the disc 352 is shown in FIG. 27. If the adjustment screw 346 is then rotated in the first direction, the disc 352 moves away from the cover 348, i.e. closer to the exterior surface of the second body section 310 inside the first offset portion 324.

FIG. 26 shows the position of the disc 352 when it is in the mid-spacing position between the cover 348 and the exterior surface of the second body section 310 inside the first offset portion 324.

If the adjustment screw 346 is further rotated in the first direction, the disc 352 will move further away from the cover 348, i.e. closer to the exterior surface of the second body section 310 inside the first offset portion 324, until the first face 352a substantially abuts the exterior surface of the second body section 310 inside the first offset portion 324. At this position, the disc 352 is at the maximum spacing from the cover 348; this is also the position of the disc 352 when it is at the minimum spacing from the exterior surface of the second body section 310 inside the first offset portion 324. At this position of the disc 352, the volume of the chamber 340 is at the minimum.

Since the chamber 340 is in communication with the passage 180 and the confined space formed by the piston 12 and the piston support 22, decreasing the volume of the chamber 340 results in the compressible fluid in the chamber 340, the passage 180 and the confined space formed by the piston 12 and the piston support 22 being compressed. This results in a higher set pressure for the valve 300. Conversely, increasing the volume of the chamber 340 results in the compressible fluid in the chamber 340, the passage 180 and the confined space formed by the piston 12 and the piston support 22 being decompressed. This results in a lower set pressure for the valve 300.

To adjust the set pressure of the valve 300 to a desired set pressure, a pressure gauge is provided downstream of the outlet opening 302b of the valve 300, in conventional manner The set pressure adjuster 306 is then operated as herein before described to increase or decrease the set pressure until the pressure gauge show that the desired set pressure has been reached.

### Embodiments of Valve Cartridge Kits

In a further aspect of the present invention, embodiments of valve cartridge kits with adjustable set pressure are also provided. Such embodiments are similar to the valve cartridge kits 3, 4, 5 and 6 of the first, second, third and fourth embodiments of valve cartridge kits as herein before described, except that the embodiments with set pressure adjustment include the components of the valve cartridge 7/8 of the fifth or sixth embodiments. The installation of such embodiments in valves and their use and operation_in valves is substantially the same as the use and operation of the corresponding embodiments of the valve cartridges, valve cartridge kits and valves, herein before described, and will not be again herein described. It will be understood that such use and operation applies mutatis mutandis to the embodiments of valve cartridge kits with adjustable set pressure and the valves in which such an embodiment of a valve cartridge kit is installed.

### Illustrative Examples

By way of example as to the set pressures that may be achieved with valve cartridges and valve cartridge kits having adjustable set pressure, in a typical installation, a spring 93 may be selected such that the valve 300 would have a set pressure of either 350 kPa or 500 kPa with the adjustment screw 346 in its nominal position (i.e. approximately in the middle of the adjustment range, as shown in FIG. 26). The adjustment screw 346 may then be used to adjust the set pressure of the valve 300 by about +/−100 kPa or perhaps +/−50 kPa. It is preferable to select an appropriate spring 93 to increase the set pressure because if only compressed fluid was used to set a valve to say 500 kPa, variations in the ambient temperature could noticeably affect the set pressure (based on the Ideal gas law).

The embodiments of the valve cartridges and valve cartridge kits having adjustable set pressure are physically larger than the embodiments that do not have adjustable set pressure, since they have to incorporate the passage 180. Consequently, such embodiments of the valve cartridges and valve cartridge kits having adjustable set pressure are installed in valves having a larger (diameter) size than the valves in which embodiments of valve cartridges and valve cartridge kits that do not have adjustable set pressure are installed.

The valve cartridge and valve cartridge kit of the present invention may be used in any suitable valve or appliance in which a pressure limiting valve function is required.

Whilst one or more preferred embodiments of the present invention have been herein before described, the scope of the present invention is not limited to those specific embodiments, and may be embodied in other ways, as will be apparent to a person skilled in the art.

The individual features of each aspect or embodiment disclosed herein may each be combined with any or all features of the other embodiments. Furthermore, the particular features, structures or characteristics may be combined as suitable in one or more embodiments of the disclosure.

Modifications and variations such as would be apparent to a person skilled in the art are deemed to be within the scope of the present invention.

### Features

Various features and combinations of features disclosed herein are set out in the following paragraphs:
1. A valve cartridge comprising
a body provided with a valve seat,
a piston,
a piston support to support the piston whereby the piston is movably supported by the piston support such that the piston is movable between a first position and a second position, the piston being spaced from the valve seat at the first position and the piston seating on the valve seat at the second position,
wherein the piston and the piston support form a confined space, with the piston supported on the piston support, and
wherein the volume of the confined space is at a maximum when the piston is at the first position and is at a minimum when the piston is at the second position, and
wherein the piston is under bias such that the piston is biased away from the valve seat to the first position and, in use, the piston is able to seat on the valve seat in the second position when subjected to sufficient fluid pressure to counter the bias.
2. A valve cartridge having one or more of the features included in the preceding paragraph, wherein the body may be provided with the piston support.
3. A valve cartridge having one or more of the features included in the preceding paragraphs, wherein the valve cartridge may further comprise a piston retainer to retain the piston with the piston support.
4. A valve cartridge having one or more of the features included in the preceding paragraphs, wherein the piston may be supported on the piston support in a sliding manner, i.e. the piston is slidably supported on the piston support.
5. A valve cartridge having one or more of the features included in the preceding paragraphs, wherein a valve seat retainer may be provided to retain the valve seat in position on the body.
6. A valve cartridge having one or more of the features included in the preceding paragraphs, wherein the piston may have a first end and a second end with an opening at the first end. The piston may be supported by the piston support such that at least a portion of the piston support is received in an internal space of the piston.
7. A valve cartridge having one or more of the features included in the preceding paragraphs, wherein at least one seal may be provided between the piston support and the piston. The seal forms a fluid-tight seal between an inner surface of the piston and an outer surface of the piston support.
8. A valve cartridge having one or more of the features included in the preceding paragraphs, wherein the piston may be biased away from the valve seat by compressed air in the confined space formed by the piston and the piston support.
9. A valve cartridge having one or more of the features included in the preceding paragraphs, wherein the piston may be biased away from the valve seat by a spring.
10. A valve cartridge having one or more of the features included in the preceding paragraphs, wherein the spring may be positioned in the confined space formed by the piston and piston support.
11. A valve cartridge having one or more of the features included in the preceding paragraphs, wherein the piston may be provided with a first internal space. The first internal space forms at least part of the confined space.
12. A valve cartridge having one or more of the features included in the preceding paragraphs, wherein, the piston support may be provided with a second internal space. The second internal space forms at least part of the confined space.
13. A valve cartridge having one or more of the features included in the preceding paragraphs, wherein the piston support is provided with a second internal space, but the second internal space does not form part of the confined space. A wall may be provided at a first end of the piston support such that the second internal space does not form part of the confined space.
14. A valve cartridge having one or more of the features included in the preceding paragraphs, wherein the piston support is not provided with a second internal space.
15. A valve cartridge having one or more of the features included in the preceding paragraphs, wherein at least one seal may be provided at an outer surface of the body.
16. A valve cartridge having one or more of the features included in the preceding paragraphs, wherein a first opening may be provided in the body and a second opening may be provided in a wall of the piston support. A passage may extend between the first and second openings, such that the exterior of the body is in communication with the confined space.
17. A valve cartridge having one or more of the features included in the preceding paragraphs, wherein first and second seals may be provided at an outer surface of the body. The first opening is located between the first and second seals.
18. A valve comprising a
a valve body having an inlet and an outlet, the valve body comprising a first body section and a second body section,
a valve cartridge as herein before described in any one of the preceding paragraphs,
the first and second body sections being detachably connected together with the valve cartridge retained in the valve body,
wherein, in use, fluid is able to flow from the inlet through the valve cartridge to the outlet when the piston is in the first position and fluid is not able to flow from the inlet through the valve cartridge to the outlet when the piston is in the second position.
19. A valve cartridge kit comprising
a body provided with a valve seat,
a piston,
a piston support, in use, adapted to support the piston whereby, in use, the piston is movably supported by the piston support such that the piston is movable between a first position and a second position, the piston being spaced from the valve seat at the first position and the piston seating on the valve seat at the second position,
wherein the piston and the piston support form a confined space when the piston is supported on the piston support, and
wherein the volume of the confined space is at a maximum when the piston is at the first position and is at a minimum when the piston is at the second position, and
wherein, in use, the piston is under bias such that the piston is biased away from the valve seat to the first position and, in use, the piston is able to seat on the valve seat in the second position when subjected to sufficient pressure to counter the bias.
20. A valve cartridge kit having one or more of the features included in the preceding paragraphs, wherein the valve cartridge kit may further comprise a spring, in use, to bias the piston away from the valve seat.
21. A valve cartridge kit having one or more of the features included in the preceding paragraphs, wherein the valve cartridge kit may further comprise a piston stop.
22. A valve cartridge kit having one or more of the features included in the preceding paragraphs, wherein the piston of the valve cartridge kit may be provided with a first internal space. The first internal space forms at least part of the confined space.
23. A valve cartridge kit having one or more of the features included in the preceding paragraphs, wherein the piston support is provided with a second internal space. The second internal space forms at least part of the confined space.
24. A valve cartridge kit having one or more of the features included in the preceding paragraphs, wherein the piston support is provided with a second internal space, but the second internal space does not form part of the confined space. A wall may be provided at a first end of the piston support such that the second internal space does not form part of the confined space.
25. A valve cartridge kit having one or more of the features in the preceding paragraphs, wherein the piston support is not provided with a second internal space.
26. A valve cartridge kit having one or more of the features included in the preceding paragraphs, wherein at least one seal may be provided at an outer surface of the body of the valve cartridge kit.
27. A valve cartridge kit having one or more of the features included in the preceding paragraphs, wherein a first opening may be provided in the body of the valve cartridge kit and a second opening may be provided in a wall of the piston support. A passage may extend between the first and second openings, such that the exterior of the body of the valve cartridge kit is in communication with the confined space.
28. A valve cartridge kit having one or more of the features included in the preceding paragraphs, wherein first and second seals may be provided at an outer surface of the body of the valve cartridge kit. The first opening is located between the first and second seals.
29. A valve comprising
a valve body having an inlet and an outlet, the valve body comprising a first body section and a second body section,
a valve cartridge kit, as herein before described in any one of the preceding paragraphs, installed in the valve body to form a valve cartridge,
the first and second body sections being detachably connected together with the components of the valve cartridge kit retained in the valve body,
wherein, in use, fluid is able to flow from the inlet through the valve cartridge to the outlet when the piston is in the first position and fluid is not able to flow from the inlet through the valve cartridge to the outlet when the piston is in the second position.
30. A method of assembling a valve comprising
providing a valve body having an inlet and an outlet, the valve body comprising a first body section and a second body section,
installing the components of the valve cartridge kit, as herein before described, which comprises inserting the piston into the second body section, inserting the body of the valve cartridge into the second body section such that at least a portion of the piston support is received in the internal space of the piston, and attaching together the first and second body sections.
31. A method of assembling a valve having one or more of the features included in the preceding paragraphs, wherein the method may further comprise inserting a spring into the internal space in the piston prior to inserting the body into the second body section.
32. A method of assembling a valve having one or more of the features included in the preceding paragraphs, wherein the method may further comprise inserting a piston stop into the second body section prior to inserting the piston into the second body section.

1. A valve cartridge comprising
a body provided with a valve seat,
a piston,
a piston support to support the piston whereby the piston is movably supported by the piston support such that the piston is movable between a first position and a second position, the piston being spaced from the valve seat at the first position and the piston seating on the valve seat at the second position,
wherein the piston and the piston support form a confined space, with the piston supported on the piston support, and
wherein the volume of the confined space is at a maximum when the piston is at the first position and is at a minimum when the piston is at the second position, and
wherein the piston is under bias such that the piston is biased away from the valve seat to the first position and, in use, the piston is able to seat on the valve seat in the second position when subjected to sufficient pressure to counter the bias.

2. A valve cartridge according to claim 1, wherein the body is provided with the piston support.

3. A valve cartridge according to claim 1, further comprising a piston retainer to retain the piston with the piston support.

4. A valve cartridge according to claim 2, wherein the piston is supported on the piston support in a sliding manner

5. A valve cartridge according to claim 1, wherein a valve seat retainer is provided to retain the valve seat in position on the body.

6. A valve cartridge according to claim 1, wherein the piston has a first end and a second end with an opening at the first end is supported by the piston support such that at least a portion of the piston support is received in an internal space of the piston.

7. A valve cartridge according to claim 1, wherein at least one seal may be provided between the piston support and the piston.

8. A valve cartridge according to claim 1, wherein the piston is biased away from the valve seat by compressed air in the confined space formed by the piston and piston support.

9. A valve cartridge according to claim 1, wherein the piston is biased away from the valve seat by a spring.

10. A valve cartridge according to claim 9, wherein the spring is positioned in the confined space formed by the piston and piston support.

11. A valve cartridge according to claim 1, wherein the piston is provided with a first internal space and wherein the first internal space forms at least part of the confined space.

12. A valve cartridge according to claim 1, wherein the piston support is provided with a second internal space and wherein the second internal space forms at least part of the confined space.

13. A valve cartridge according to claim 1, wherein at least one seal is provided at an outer surface of the body.

14. A valve cartridge according to claim 1, wherein a first opening is provided in the body, a second opening is provided in a wall of the piston support and a passage extends between the first and second openings, such that the exterior of the body is in communication with the confined space.

15. A valve cartridge according to claim 14, wherein first and second seals are provided at an outer surface of the body and the first opening is located between the first and second seals.

16. A valve comprising
a valve body having an inlet and an outlet, the valve body comprising a first body section and a second body section,
a valve cartridge according to claim 1,
the first and second body sections being detachably connected together with the valve cartridge retained in the valve body,
wherein, in use, fluid is able to flow from the inlet through the valve cartridge to the outlet when the piston is in the first position and fluid is not able to flow from the inlet through the valve cartridge to the outlet when the piston is in the second position.

17. A valve cartridge kit comprising
a body provided with a valve seat,
a piston,
a piston support, in use, adapted to support the piston whereby, in use, the piston is movably supported by the piston support such that the piston is movable between a first position and a second position, the piston being spaced from the valve seat at the first position and the piston seating on the valve seat at the second position,
wherein the piston and the piston support form a confined space when the piston is supported on the piston support, and
wherein the volume of the confined space is at a maximum when the piston is at the first position and is at a minimum when the piston is at the second position, and
wherein, in use, the piston is under bias such that the piston is biased away from the valve seat to the first position and, in use, the piston is able to seat on the valve seat in the second position when subjected to sufficient pressure to counter the bias.

18. A valve cartridge kit according to claim 17, further comprising a spring, in use, to bias the piston away from the valve seat.

19. A valve cartridge kit according to claim 17, further comprising a piston stop.

20. A valve cartridge kit according to claim 17, wherein at least one seal is provided at an outer surface of the body of the valve cartridge kit.

21. A valve cartridge kit according to claim 17, wherein a first opening is provided in the body of the valve cartridge kit, a second opening is provided in a wall of the piston support and a passage extends between the first and second openings, such that the exterior of the body of the valve cartridge kit is in communication with the confined space.

22. A valve cartridge kit according to claim 21, wherein first and second seals are provided at an outer surface of the body of the valve cartridge kit and the first opening is located between the first and second seals.

23. A valve comprising
a body having an inlet and an outlet, the body comprising a first body section and a second body section,
a valve cartridge kit, according to claim 17, installed in the valve body to form a valve cartridge,
the first and second body sections being detachably connected together with the components of the valve cartridge kit retained in the valve body,
wherein, in use, fluid is able to flow from the inlet through the valve cartridge to the outlet when the piston is in the first position and fluid is not able to flow from the inlet through the valve cartridge to the outlet when the piston is in the second position.

24. A method of assembling a valve comprising
providing a valve body having an inlet and an outlet, the valve body comprising a first body section and a second body section,
installing the components of a valve cartridge kit according to claim 17, which comprises
inserting the piston into the second body section, inserting the body of the valve cartridge kit into the second body section such that at least a portion of the piston support is received in the internal space of the piston, and attaching together the first and second body sections.

25. A method according to claim 24, further comprising inserting a spring into the internal space in the piston prior to inserting the body into the second body section.

26. A method according to claim 24, further comprising inserting a piston stop into the second body section prior to inserting the piston into the second body section.
